(19) United States
(12) Patent Application Publication
(10) Pub. No.: US 2026/0291010 A1
(43) Pub. Date: Sep. 24, 2026

(54) A RECHARGEABLE LITHIUM METAL CELL

(71) Applicant: Commonwealth Scientific and Industrial Research Organisation, Acton (AU)

(72) Inventors: Tsutomu SADA, Kyoto (JP); John CHIEFARI, Clayton (AU); Adam BEST, Clayton (AU); Nino MALIC, Clayton (AU)

(21) Appl. No.: 19/476,483

(22) PCT Filed: Apr. 19, 2024
(86) PCT No.: PCT/AU2024/050375

§ 371 Date: Oct. 17, 2025

(30) Foreign Application Priority Data
Apr. 19, 2023 (AU) 2023901163

(51) Int. Cl. H01M 50/451; H01M 4/02; H01M 4/131; H01M 4/134; H01M 10/0525; H01M 10/0585; H01M 10/42; H01M 10/54; H01M 50/457; H01M 50/46; H01M 50/491

(52) U.S. Cl. CPC H01M 50/451; H01M 4/131; H01M 4/134; H01M 10/0525; H01M 10/0585; H01M 10/4235; H01M 10/54; H01M 50/457; H01M 50/461; H01M 50/491; H01M 2004/027; H01M 2004/028

(57) ABSTRACT

The invention provides a rechargeable lithium metal cell, comprising: an anode comprising lithium metal; a cathode comprising a high-voltage cathode material; and a plurality of lithium-conductive layers interposed between the anode and the cathode, the lithium-conductive layers comprising a solid polymeric anolyte layer adjacent the anode and one or more further electrolyte layers which space apart the polymeric anolyte layer from the cathode, wherein the solid polymeric anolyte layer comprises (i) a block copolymer comprising at least one hydrophobic non-ionic block and at least one ionic block, and (ii) lithium salt, and wherein the solid polymeric anolyte layer has at least two glass transition temperature (Tg) values.

### PRIORITY CROSS-REFERENCE

The present application claims priority from Australian provisional patent application No. 2023901163 filed on 19 Apr. 2023, the contents of which should be considered to be incorporated into this specification by this reference.

### TECHNICAL FIELD

The invention relates to a rechargeable lithium metal cell comprising a lithium metal anode, a high-voltage cathode and a plurality of lithium-conductive layers interposed between the anode and the cathode. The lithium-conductive layers include a solid polymeric anolyte layer adjacent the anode and one or more further electrolyte layers which space apart the solid polymeric anolyte layer from the cathode. The solid polymeric anolyte layer comprises a block copolymer, comprising a hydrophobic non-ionic block and an ionic block, and lithium salt. The invention further relates to a method of cycling the rechargeable lithium metal cell; a method of producing the rechargeable lithium metal cell, and a cathode half-cell for producing the rechargeable lithium metal cell.

### BACKGROUND OF INVENTION

Rechargeable lithium batteries are now ubiquitous in society. However, for many applications, it is desirable to increase the energy density beyond that of commercially available lithium-ion batteries. In principle, significant improvements may be achieved by replacing the graphite anode with an anode material having a higher specific capacity. Metallic lithium, with a specific capacity of 3,860 mAh·g⁻¹, is the ideal anode material for high energy density batteries. However, the development of commercially acceptable lithium metal batteries has been impeded by significant challenges including poor cyclability and safety risks. Notably, lithium metal cells are susceptible to cell failure caused by dendrite growth on the anode over multiple charge-discharge cycles and to poor coulombic efficiencies and capacity fading due to reactions of the lithium metal with the electrolyte or moisture.

One approach to mitigate these issues is to replace the traditional liquid electrolyte with a solid-state electrolyte. Solid polymeric electrolytes provide a particularly promising approach to improve the overall electrochemical performance and safety of lithium metal cells due to their good shape flexibility, suppression of dendrite growth, removal of leakage issues and lower flammability relative to liquid electrolytes.

Block copolymer-based electrolytes have recently attracted attention due to their highly customisable chemical nature, allowing a good balance to be struck between competing imperatives to impart to the electrolyte composition: (i) a sufficiently high modulus to suppress dendrite growth, (ii) good chemical and electrochemical stability in contact with the lithium metal anode; and (iii) sufficient ionic conductivity for satisfactory cell performance. Suitable block copolymers generally include hydrophobic and polar blocks which phase-separate in the solid state to provide a composite-like electrolyte structure comprising mechanically robust hydrophobic domains and an interconnecting network of polar domains through which lithium ion conduction can occur.

Solid polymeric electrolytes comprising such block copolymers have been disclosed, for example, in WO2019/084623, where they were used successfully in a simple, low voltage cell (lithium iron phosphate cathode | block copolymer electrolyte | Li metal anode).

Another approach to increase the energy density of lithium batteries is to increase the operating voltage. This requires the selection of a cathode material with a large electrochemical potential difference relative to the anode when fully charged, for example at least 4 V vs Li/Li⁺ but preferably significantly higher than this. Examples of such materials include nickel-rich layered oxides such as LiNi_{0.6}Co_{0.2}Mn_{0.2}O₂ (NCM622) and LiNi_{0.8}Co_{0.1}Mn_{0.1}O₂ (NCM811) which have electrochemical potentials of 4.3V vs Li/Li⁺ or higher.

A particularly desirable high energy cell would thus combine a lithium metal anode with a cathode comprising a high-voltage cathode material. However, such a combination imposes a demanding set of requirements on the electrolyte, which must be compatible with the high-voltage cathode over the required lifetime of the cell, while still addressing the anode-related challenges (discussed above) and providing satisfactory lithium conductivity during cycling.

There is therefore an ongoing need for rechargeable lithium metal cells which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

The inventors have now developed high energy density lithium metal cells in which a lithium metal anode and a high-voltage cathode are separated by multiple lithium-conductive electrolyte layers in a laminate electrolyte structure. The electrolyte layers include a solid polymeric anolyte layer adjacent the anode, the composition of which includes a block copolymer comprising a hydrophobic non-ionic block and an ionic block combined with lithium salt. One or more further electrolyte layers space apart the solid polymeric anolyte layer from the cathode. Cells of this type have been found capable of extended cycling with good coulombic efficiency and capacity retention at charge cut-off voltages of 4.3 or 4.5V. Without wishing to be limited by any theory, it is proposed that separation of the solid polymeric anolyte layer from the cathode is important to avoid or acceptably limit chemical and electrochemical oxidative degradation processes which would otherwise occur during cycling of the cell when the solid polymeric anolyte layer is in direct contact with the high-voltage cathode material.

The inventors have shown that a variety of different solid-state and/or liquid electrolyte spacer layers can compatibilise the high-voltage cathode and solid polymeric anolyte layer to provide high energy cells with excellent cycling performance. In some preferred embodiments, one or more of (or each of) the further electrolyte layers comprises a liquid organic electrolyte component, such as a free ionic liquid. For example, the liquid organic electrolyte component may be present as an additive in a solid-state electrolyte composition. Without wishing to be limited by any theory, it is proposed that the liquid organic electrolyte component mobilises lithium ions and/or softens the electrolyte composition, thus facilitating lithium conductivity through the lithium-conductive layer in which it is present and/or across the interface between that layer and an adjacent layer in the cell.

In accordance with a first aspect the invention provides a rechargeable lithium metal cell, comprising: an anode comprising lithium metal; a cathode comprising a high-voltage cathode material; and a plurality of lithium-conductive layers interposed between the anode and the cathode, the lithium-conductive layers comprising a solid polymeric anolyte layer adjacent the anode and one or more further electrolyte layers which space apart the polymeric anolyte layer from the cathode, wherein the solid polymeric anolyte layer comprises (i) a block copolymer comprising at least one hydrophobic non-ionic block and at least one ionic block, and (ii) lithium salt, and wherein the solid polymeric anolyte layer has at least two glass transition temperature (Tg) values.

In some embodiments, the high-voltage cathode material has an electrochemical potential of at least 4.1 V vs Li/Li⁺, or at least 4.25 V vs Li/Li⁺, or at least 4.35 V vs Li/Li⁺, such as at least 4.5 V vs Li/Li⁺.

In some embodiments, the high-voltage cathode material comprises one or more metals selected from nickel, cobalt and manganese.

In some embodiments, the high voltage cathode material is selected from the group consisting of a nickel-rich layered oxide, a lithium-rich layered oxide, a high-voltage spinel oxide and a high-voltage polyanionic compound.

In some embodiments, the high voltage cathode material is a nickel-rich layered oxide of the form LiNiₓCo_{y}M_{z}O₂ wherein M is selected from Mn, Al and combinations thereof, x+y+z=1 and x≥0.6.

In some embodiments, the rechargeable lithium metal cell retains at least 90% of capacity after 100 charge-discharge cycles conducted at 0.2 C and 50° C. with a charge cut-off voltage of at least 4.25 V, such as at least 4.35 V, for example at least 4.5 V. In some embodiments, the rechargeable lithium metal cell retains at least 85% of capacity after 100 charge-discharge cycles conducted at 0.2 C and 25° C. with a charge cut-off voltage of at least 4.25 V, preferably at least 4.35 V, more preferably at least 4.5 V, such as 4.6 V.

In some embodiments, the molecular weight of the block copolymer is greater than 50,000 g/mol, such as greater than 100,000 g/mol. In some embodiments, the molecular weight of at least one hydrophobic non-ionic block of the block copolymer is greater than its entanglement molecular weight, optionally greater than 18,000 g/mol, such as greater than 25,000 g/mol.

In some embodiments, the block copolymer is a triblock copolymer of the form A-B-A, wherein each A is a hydrophobic non-ionic block and B is the ionic block.

In some embodiments, the at least one hydrophobic non-ionic block comprises polymerised residues of hydrophobic monomers and the at least one ionic block comprises polymerised monomer residues having covalently coupled thereto (a) a pendant organic ionic liquid cation, the pendant organic ionic liquid cation having a counter anion, (b) a pendant anionic moiety, the pendant anionic moiety having a counter cation, or (c) a combination thereof.

In some embodiments, the at least one ionic block comprises polymerised monomer residues having covalently coupled thereto a pendant organic ionic liquid cation, such as one selected from imidazolium, pyrrolidinium, phosphonium, pyridinium and ammonium cations, for example a dialkyl imidazolium cation.

In some embodiments, the solid polymeric anolyte layer comprises the lithium salt in an amount of at least 10 wt. %.

In some embodiments, the solid polymeric anolyte layer further comprises an organic electrolyte selected from a free ionic liquid, a polar aprotic molecular compound and combinations thereof.

In some embodiments, the solid polymeric anolyte layer has a thickness of less than 50 μm, such as less than 20 μm, for example between 0.5 and 10 μm.

In some embodiments, the solid polymeric anolyte layer is a coating on the anode.

In some embodiments, the polymeric anolyte layer is spaced apart from the cathode by less than 100 μm, such as less than 50 μm, for example by a separation distance in the range of 15 to 45 μm.

In some embodiments, at least one of the further electrolyte layers comprises an organic electrolyte selected from a free ionic liquid, a polar aprotic molecular compound and combinations thereof. In some embodiments, at least two of the further electrolyte layers comprises the organic electrolyte. In some embodiments, each of the further electrolyte layers comprises an organic electrolyte selected from a free ionic liquid, a polar aprotic molecular compound and combinations thereof.

In some embodiments, at least one of the further electrolyte layers comprises a free ionic liquid. In some embodiments, at least two of the further electrolyte layers comprises a free ionic liquid. In some embodiments, each of the further electrolyte layers comprises a free ionic liquid. The free ionic liquid may be present in an amount of at least 1 wt. %, such as at least 2 wt. %, or at least 5 wt. %, such as at least 10 wt. %, relative to the total weight of the further electrolyte layer(s) in which it is present.

In some embodiments, the one or more further electrolyte layers comprise a solid catholyte layer adjacent the cathode, wherein the solid catholyte layer is selected from a solid polymeric catholyte layer and a solid inorganic electrolyte layer.

In some embodiments, the solid catholyte layer adjacent the cathode is a solid inorganic electrolyte layer comprising a lithium-containing inorganic material selected from a garnet, a NASICON-type material, a sulfide and a perovskite.

In some embodiments, the solid polymeric catholyte layer adjacent the cathode is a solid polymeric catholyte layer.

In some embodiments, the solid polymeric catholyte layer comprises a fluorinated polymer. The fluorinated polymer may comprise a carbon-chain backbone. The fluorinated polymer may comprise polymerised vinylidene difluoride units. In some embodiments, the fluorinated polymer is an ionic fluorinated polymer. In some embodiments, the fluorinated polymer is an ionic fluorinated polymer comprising a carbon-chain backbone and pendant ionic groups covalently coupled to the carbon-chain backbone.

In some embodiments, the pendant ionic groups comprise a plurality of organic ionic liquid cations. The organic ionic liquid cations may be selected from the group consisting of quaternary ammonium, imidazolium, benzimidazolium, pyrrolidinium, pyrrolium, indolium, carbazolium, pyridinium, quinolinium, piperidinium, piperazinium, phosphonium and sulfonium cations. In some embodiments, the organic ionic liquid cations comprise or consist of quaternary ammonium cations. In some embodiments, the pendant ionic groups comprise a plurality of polymerised monomer residues, each polymerized monomer residue having covalently coupled thereto an organic ionic liquid cation. In some embodiments, the pendant ionic groups are produced by graft polymerization of an ionic monomer onto the carbon-chain backbone, the ionic monomer comprising (i) a polymerizable ethylenically unsaturated functional group, and (ii) an organic ionic liquid cation.

In some embodiments, the solid polymeric catholyte layer comprises lithium salt and at least one selected from a free ionic liquid and a poly(alkylene oxide).

In some embodiments, the one or more further electrolyte layers comprise an intermediate electrolyte layer interposed between the solid polymeric anolyte layer and the solid catholyte layer, e.g. between the solid polymeric anolyte layer and the solid polymeric catholyte layer. The intermediate electrolyte layer may be selected from a solid polymeric electrolyte layer, a solid inorganic electrolyte layer and a liquid electrolyte layer. The intermediate electrolyte layer may facilitate lithium ion conduction between the solid polymeric catholyte layer and the solid polymeric anolyte layer in use.

In some embodiments, the intermediate electrolyte layer comprises a lithium-conductive polymeric composition comprising (i) an ionic fluorinated polymer comprising a carbon-chain backbone and pendant ionic groups covalently coupled to the carbon-chain backbone, (ii) lithium salt, and optionally (iii) a free ionic liquid.

In some embodiments, the intermediate electrolyte layer comprises a porous separator infiltrated with a lithium-conductive polymeric composition or a liquid electrolyte comprising lithium salt.

In some embodiments, the intermediate electrolyte layer comprises a solid inorganic electrolyte layer comprising mobile lithium ions. The solid inorganic electrolyte layer may comprise a lithium-containing inorganic material selected from a garnet, a NASICON-type material, a sulfide and a perovskite.

In some embodiments, the one or more further electrolyte layers comprise a porous separator infiltrated with a liquid electrolyte comprising lithium salt. The liquid electrolyte may comprise a free ionic liquid.

In some embodiments, the one or more further electrolyte layers comprise a solid inorganic electrolyte layer comprising mobile lithium ions. The solid inorganic electrolyte layer may comprise a lithium-containing inorganic material selected from a garnet, a NASICON-type material, a sulfide and a perovskite.

In some embodiments, the one or more further electrolyte layers comprise a second polymeric anolyte layer comprising (i) a block copolymer comprising at least one hydrophobic non-ionic block and at least one ionic block, and (ii) lithium salt, the second polymeric anolyte layer adjacent the solid polymeric anolyte layer and spaced apart from the cathode.

In some embodiments, the further electrolyte layers comprise: (i) a solid catholyte layer adjacent the cathode, according to any of the embodiments disclosed herein, (ii) a second polymeric anolyte layer adjacent the solid polymeric anolyte layer, according to any of the embodiments disclosed herein, and (iii) an intermediate electrolyte layer interposed between the solid polymeric anolyte layer and the solid catholyte layer, according to any of the embodiments disclosed herein. The intermediate electrolyte layer may thus be directly adjacent to both the solid catholyte layer and the second polymeric anolyte layer (i.e. sandwiched between these layers).

In some embodiments, each lithium-conductive layer is a solid-state electrolyte.

In accordance with a second aspect the invention provides a method of cycling the rechargeable lithium metal cell according to any embodiment of the first aspect, the method comprising one or more cycles of (i) charging the rechargeable lithium metal cell to a charge cut-off voltage of at least 4.1 V, and (ii) discharging the rechargeable lithium metal cell.

In some embodiments, the charge cut-off voltage is at least 4.25 V, such as at least 4.35 V, for example at least 4.5 V.

In accordance with a third aspect the invention provides a method of producing a rechargeable lithium metal cell according to any embodiment of the first aspect, the method comprising: providing an anode half-cell comprising the anode; providing a cathode half-cell comprising the cathode; and assembling the anode half-cell and the cathode half-cell to provide the rechargeable lithium metal cell with the plurality of lithium-conductive layers interposed between the anode and the cathode.

In some embodiments, the anode half-cell comprises the solid polymeric anolyte layer adhered to the anode before assembling the anode half-cell and the cathode half-cell.

In some embodiments, providing the anode half-cell comprises producing the solid polymeric anolyte layer adhered to the anode by a coating technique selected from slot-die coating, comma coating or melt extrusion.

In some embodiments, the cathode half-cell comprises, as an outer layer, a second polymeric anolyte layer comprising the block copolymer and lithium salt, and assembling the anode half-cell and the cathode half-cell comprises bonding the solid polymeric anolyte layer to the second polymeric anolyte layer.

In some embodiments, the cathode half-cell comprises a solid catholyte layer, e.g. a solid polymeric catholyte layer, adjacent the cathode.

In accordance with a fourth aspect the invention provides a cathode half-cell comprising: a cathode comprising a high-voltage cathode material, the cathode supported on a current collector; a solid polymeric anolyte layer; and one or more further electrolyte layers which space apart the solid polymeric anolyte layer from the cathode, wherein the solid polymeric anolyte layer comprises (i) a block copolymer comprising at least one hydrophobic non-ionic block and at least one ionic block, and (ii) lithium salt, and wherein the solid polymeric anolyte layer has at least two glass transition temperature (Tg) values.

In some embodiments, the one or more further electrolyte layers comprise a solid catholyte layer, e.g. a solid polymeric catholyte layer, adjacent the cathode. The solid polymeric catholyte layer may comprises a fluorinated polymer. The fluorinated polymer may comprise a carbon-chain backbone. The fluorinated polymer may comprise polymerised vinylidene difluoride units. The fluorinated polymer may be an ionic fluorinated polymer.

It will be appreciated that other features of the invention according to the third and fourth aspects may be as disclosed herein in relation to the first aspect.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

As used herein, the terms “first”, “second”, “third” etc in relation to various features of the disclosed devices, methods, systems etc are arbitrarily assigned and are merely intended to differentiate between two or more such features that the device, methods, systems etc may incorporate in various embodiments. The terms do not of themselves indicate any particular orientation or sequence. Moreover, it is to be understood that the presence of a “first” feature does not imply that a “second” feature is present, the presence of a “second” feature does not imply that a “first” feature is present, etc.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts a rechargeable lithium metal cell according to the invention.

FIG. 2 schematically depicts a rechargeable lithium metal cell according to some embodiments of the invention, in which the cell comprises a second polymeric anolyte layer adjacent to the solid polymeric anolyte layer but spaced apart from the cathode by one or more further electrolyte layers.

FIG. 3 schematically depicts a rechargeable lithium metal cell according to some embodiments of the invention, in which the cell comprises a solid polymeric catholyte layer adjacent the cathode and an intermediate electrolyte layer interposed between the solid polymeric catholyte layer and the solid polymeric anolyte layer.

FIG. 4 schematically depicts a rechargeable lithium metal cell according to some embodiments of the invention, in which the cell comprises, as a further electrolyte layer which spaces apart the solid polymeric anolyte layer from the cathode, a porous separator infiltrated with a liquid electrolyte comprising lithium salt.

FIG. 5 schematically depicts a rechargeable lithium metal cell according to some embodiments of the invention, in which the cell comprises, as a further electrolyte layer which spaces apart the solid polymeric anolyte layer from the cathode, a solid inorganic electrolyte layer comprising mobile lithium ions.

FIG. 6 schematically depicts a method of producing the rechargeable lithium metal cell of FIG. 2.

FIG. 7 is a plot of voltage vs capacity when cycling a lithium metal cell comprising multiple solid polymeric electrolyte layers at 0.1 C, 0.2 C and 0.5 C, as performed in Example 2.

FIG. 8 is a plot of voltage vs capacity when cycling a lithium metal cell comprising an ionic liquid electrolyte layer at 0.1 C, 0.2 C and 0.5 C, as performed in Example 3.

FIG. 9 is a plot of voltage vs capacity when cycling a lithium metal cell comprising a solid-state garnet-based electrolyte layer, at 0.1 C, 0.2 C and 0.5 C, as performed in Example 4.

FIG. 10 is a plot of voltage vs capacity when cycling a lithium metal cell comprising a solid-state NASICON-based electrolyte layer, at 0.1 C, 0.2 C and 0.5 C, as performed in Example 5.

FIG. 11 is a plot of voltage vs capacity when cycling a lithium metal cell comprising a solid-state sulfide-based electrolyte layer, at 0.1 C, 0.2 C and 0.5 C, as performed in Example 6.

FIG. 12 is a plot of voltage vs capacity when cycling a lithium metal cell comprising a Pilblox-based solid polymeric anolyte layer directly adjacent the cathode, at 0.1 C and 0.2 C, as performed in Example 7.

### DETAILED DESCRIPTION

The present invention relates to a rechargeable lithium metal cell. The rechargeable lithium metal cell includes an anode comprising lithium metal, a cathode comprising a high-voltage cathode material, and a plurality of lithium-conductive layers interposed between the anode and the cathode. The lithium-conductive layers include a solid polymeric anolyte layer adjacent the anode and one or more further electrolyte layers which space apart the polymeric anolyte layer from the cathode. The solid polymeric anolyte layer comprises: (i) a block copolymer comprising at least one hydrophobic non-ionic block and at least one ionic block, and (ii) lithium salt. The solid polymeric anolyte layer has at least two glass transition temperature (Tg) values.

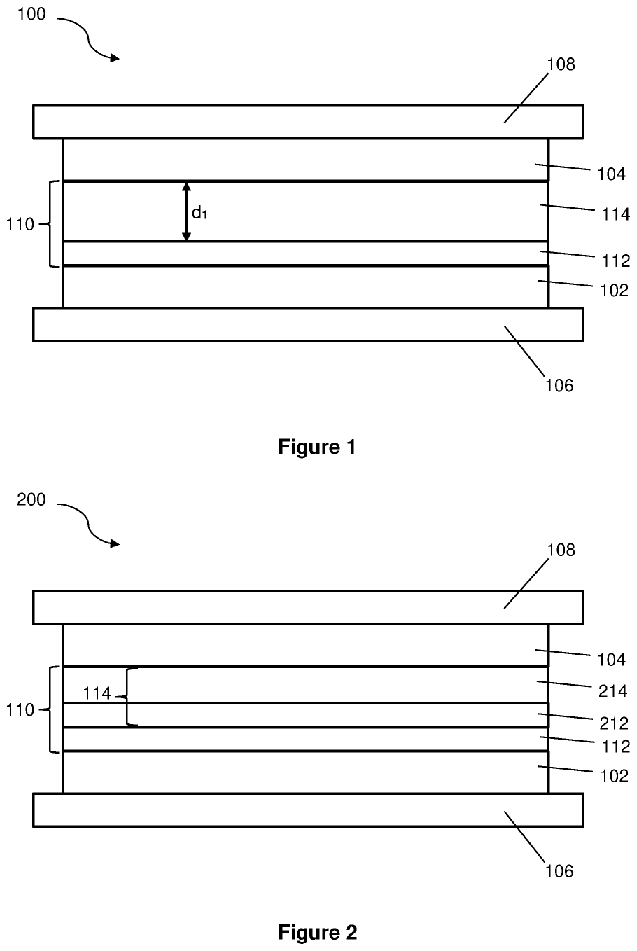

Schematically depicted in FIG. 1 is a rechargeable lithium metal cell 100 according to some embodiments of the invention. Cell 100 includes lithium metal anode 102 and high-voltage cathode 104, which are present on anodic current collector 106 and cathodic current collector 108 respectively. Cell 100 may thus be connected to other cells in a battery and/or an external circuit via electrical connections to the current collectors. Cell 100 includes a plurality of lithium-conductive layers 110 which are interposed between anode 102 and cathode 104. These layers include solid polymeric anolyte layer 112 adjacent to anode 102 and one or more further electrolyte layers 114 which space apart polymeric anolyte layer 112 from cathode 104 by a distance depicted as di in FIG. 1. The one or more further electrolyte layers 114 may include only a single further electrolyte layer as depicted in FIG. 1 but may alternatively include two or more layers as will be explained hereafter.

Rechargeable lithium metal cells according to the present disclosure, alternatively known as secondary lithium metal cells, may be present in a rechargeable battery, optionally in combination with other similar or different rechargeable cells. It will be appreciated that the rechargeable battery may comprise additional conventional battery components such as hermetic packaging, electrical contacts and the like.

### Anode

The rechargeable cell disclosed herein includes an anode (also known as a negative electrode) which comprises, and typically consists of, lithium metal. Metallic lithium is an ideal anode material for high energy secondary batteries due to its high specific capacity (3,860 mAh·g⁻¹) and very low electrochemical potential. However, lithium metal cells are susceptible to failure caused by dendrite growth on the anode over multiple charge-discharge cycles of the cell and also to poor Coulombic efficiencies and capacity fading due to reactions of the lithium metal with the electrolyte or moisture. Without wishing to be limited by any theory, it is believed that the excellent cycling performance obtained with high-voltage lithium metal batteries configured as disclosed herein is due at least in part to the mitigation of one or more of these anode-related issues.

The anode may comprise a layer of metallic lithium having at least a thickness sufficient for the required charge capacity of the cell. For example, the anode may comprise a layer of lithium metal having a thickness of between 5 μm and 50 μm, for example between 15 μm and 30 μm. The metallic lithium anode may be present on a current collector, for example a metallic current collector such as copper foil. For example, the anode may comprise a layer of metallic lithium having a thickness of between 5 μm and 50 μm, for example 10 μm or 20 μm, laminated onto a copper foil current collector having a thickness of between 5 μm and 50 μm, for example 10 μm.

### Cathode

The rechargeable lithium metal cells disclosed herein include a cathode (also known as a positive electrode) which comprises a high-voltage cathode material. As used herein, a cathode material for a lithium-based cell is the electroactive material of the cathode capable of incorporating lithium ions in a reduction half-reaction during discharge of the cell.

Commercially available lithium batteries operating with liquid organic carbonate electrolytes are typically restricted to discharge voltages of below approximately 4 V since the organic electrolyte is susceptible to oxidation at higher voltages. However, the energy density of a cell corresponds to the product of its specific capacity (charge capacity per unit mass) and its operating voltage (difference in electrochemical potential between cathode and anode during discharge). It would therefore be desirable to develop cells that can operate stably at higher voltages, using suitably high-voltage cathode materials with good specific capacities.

In the context of lithium metal cells, high-voltage cathode materials are those which have a large electrochemical potential difference relative to the lithium metal anode when fully charged, and in particular an electrochemical potential of more than 4 V vs Li/Li⁺. In some embodiments of the cells disclosed herein, the high-voltage cathode material has an electrochemical potential of at least 4.1 V vs Li/Li⁺, or at least 4.25 V vs Li/Li⁺, such as at least 4.35 V vs Li/Li⁺, for example at least 4.5 V vs Li/Li⁺.

In some embodiments, the high-voltage cathode material has a specific capacity of at least 150 mA·h·g⁻¹, for example at least 200 mA·h·g⁻¹.

In some embodiments, the high-voltage cathode material comprises one or more metals selected from nickel, cobalt and manganese. For example, the high voltage cathode material may be a nickel-rich layered oxide, a lithium-rich layered oxide, a high-voltage spinel oxide or a high-voltage polyanionic compound.

Suitable nickel-rich layered oxides may have the form LiNiₓCo_{y}M_{z}O₂ where M is selected from Mn, Al and combinations thereof, x+y+z=1 and x≥0.6. Specific examples of suitable nickel-rich layered oxides include LiNi_{0.6}Co_{0.2}Mn_{0.2}O₂ (NCM622) and LiNi_{0.8}Co_{0.1}Mn_{0.1}O₂ (NCM811) which are suitable for 4.3V and 4.6V lithium metal cells respectively.

Suitable lithium-rich layered oxides may have the form Li₁₊ₓM₁₋ₓO₂ where M is selected from Mn, Ni and Co. An example of a suitable high-voltage spinel oxide is LiNi_{0.5}Mn_{1.5}O₄.

The cathode comprises the high-voltage cathode material in an amount sufficient to provide the required charge capacity of the cell. In some embodiments, the cathode comprises the high-voltage cathode in an amount of at least 1.5 mAh·cm⁻², such as at least 2 mAh·cm⁻².

The high-voltage cathode material is preferably in particulate form. The cathode may further comprise other components such as a conductive additive and a polymeric binder. The conductive additive, also typically in particulate form, is included to improve the electrical conductivity of the cathode material and its electrical contact with the current collector. The conductive additive may be a carbon-based particulate, such a carbon black and the like.

The binder may in principle be any polymeric material with sufficient thermal and chemical stability to withstand the chemical environment and electrochemical processes in the cell, particularly stability against oxidation by the high-voltage cathode material, and which is capable of binding the particulate components of the cathode together and to the current collector. A common polymeric binder used in lithium ion batteries is a polyvinylidene difluoride (PVDF), which is favoured due to its high thermal and electrochemical stability as well as its excellent adhesive properties. Non-conductive binders may however act as insulators against ionic conduction. In some embodiments, therefore, the binder is a conductive binder, in particular an ionic polymer binder. In some embodiment, the binder comprises an ionic fluorinated polymer. In some embodiments, the binder comprises an ionic fluorinated polymer comprising pendant ionic groups covalently coupled to the carbon-chain backbone of the polymer, for example of the type described herein in greater detail below in the context of the solid polymeric catholyte layer. Such binders have been found suitable to consolidate the particulate cathode components while providing excellent ionic conductivity and resistance against oxidation by the high-voltage cathode material.

The cathode may comprise a layer of particulate components, including the high-voltage cathode material and conductive additive when present, having a suitable thickness and cathode material loading density to provide the required charge capacity of the cell. The cathode layer may be present on a current collector, for example a metallic current collector such as aluminium foil. The particulate components may be held together, and to the current collector, by the polymeric binder. Nevertheless, the resultant composite of particulate components and binder may be porous.

Advantageously, the porous structure of the cathode may allow infiltration of a solid polymeric catholyte composition into the cathode, as will be described hereafter.

### Lithium-Conductive Layers

The rechargeable lithium metal cells disclosed herein include a plurality of lithium-conductive layers interposed between the anode and the cathode. The role of the lithium-conductive layers, collectively, is to electrically isolate the anode from the cathode and facilitate facile transport of lithium ions between the anode and cathode during cell cycling (low internal resistance), and to do this while avoiding or acceptably limiting undesirable processes leading to capacity fading or battery failure, such as irreversible redox reactions of electrolyte components at the cathode or anode or non-uniform lithium electroplating on the anode.

The lithium-conductive layers include a solid polymeric anolyte layer adjacent the anode and one or more further electrolyte layers which space apart the polymeric anolyte layer from the cathode. In some embodiments, the polymeric anolyte layer is spaced apart from the cathode by less than 100 μm, such as less than 50 μm, for example in the range of 15 to 45 μm. Such a separation distance may avoid or acceptably limit undesirable reactions between the polymeric anolyte layer and the cathode while ensuring that the internal resistance of the cell remains acceptably low.

In some embodiments, each lithium-conductive layer is a solid-state electrolyte (SSE). Solid-state electrolytes, including but not limited to polymeric solid-state electrolytes, may provide an improvement of the overall electrochemical performance and safety of lithium-based devices due to their good shape flexibility, removal of leakage issues and lower flammability relative to liquid electrolytes. In other embodiments, however, at least one lithium-conductive layer may comprise a liquid electrolyte, for example infiltrated through an inert porous separator.

Each lithium-conductive layer may comprise mobile lithium ions, typically present at least in one or more lithium salts where the anion is not covalently bonded to a polymeric structure or other solid phase component. Optionally, the same lithium salt may be present in each layer. The presence of mobile lithium ions through the interposed layers between anode and cathode facilitates lithium transport during discharging and charging of the cell. Suitable lithium salts will be described herein in the context of the solid polymeric anolyte layer and the further electrolyte layers.

In some embodiments, at least one of the lithium-conductive layers comprises an organic electrolyte selected from a free ionic liquid, a polar aprotic molecular compound and combinations thereof. In some embodiments, at least one of the lithium-conductive layers comprises a free ionic liquid.

The organic electrolyte (as a pure component, i.e. separate from other components of the lithium-conductive layer) may be a liquid at the operating temperature of the cell. In some embodiments, the organic electrolyte is a liquid at 50° C., or at room temperature (22° C.). As such, the organic electrolyte is able to solubilise and mobilise lithium ions during charging and discharging of the cell. Thus, the organic electrolyte facilitates lithium conductivity through the lithium-conductive layer in which it is present and/or across the interface between that layer and an adjacent layer (such as an adjacent lithium-conductive electrolyte layer).

The lithium-conductive layer (or layers) comprising the organic electrolyte may be a solid-state electrolyte or a liquid electrolyte. In a solid-state electrolyte, the organic electrolyte is thus present as an additive which is not covalently bonded to the solid components of the solid-state electrolyte. The electrolyte layer as a whole remains a solid, but the organic electrolyte additive may advantageously soften the solid-state composition, mobilise lithium cations therein and/or facilitate lithium ion conductivity across the interface with an adjacent solid-state electrolyte layer or electrode (i.e. reduce interfacial resistance). The organic electrolyte component may thus advantageously improve the performance of cells in which all electrolyte layers are solid-state electrolytes.

In embodiments where the solid-state electrolyte is a solid polymeric electrolyte layer, the solid polymeric anolyte layer may exhibit at least one glass transition temperature (Tg) value corresponding to the polymer component of the electrolyte composition. The amount of organic electrolyte may thus be limited by the imperative to avoid dissolving or excessively plasticising the polymeric components.

In some embodiments, one or more of the lithium-conductive layers is a solid-state electrolyte, e.g. a solid state polymeric electrolyte, and comprises the organic electrolyte in an amount of less than 50 wt. %, for example between about 1 wt. % and about 50 wt. %, such as between about 5 wt. % and about 35 wt. %, or between about 10 wt. % and about 30 wt. %, relative to the total weight of the solid-state electrolyte.

In some embodiments, as described in greater detail hereafter, the solid polymeric anolyte layer adjacent the anode comprises an organic electrolyte selected from a free ionic liquid, a polar aprotic molecular compound and combinations thereof.

In some embodiments, at least one of the further electrolyte layers (which space apart the polymeric anolyte layer from the cathode) comprises an organic electrolyte selected from a free ionic liquid, a polar aprotic molecular compound and combinations thereof. In some embodiments, at least one of the further electrolyte layers (which space apart the polymeric anolyte layer from the cathode) comprises a free ionic liquid. The free ionic liquid may be present in an amount of at least 1 wt. %, such as at least 2 wt. %, or at least 5 wt. %, such as at least 10 wt. %, relative to the total weight of the further electrolyte layer(s) in which it is present.

In some embodiments, the solid polymeric anolyte layer adjacent the anode and at least one of the further electrolyte layers (which space apart the polymeric anolyte layer from the cathode) each comprise an organic electrolyte independently selected from a free ionic liquid, a polar aprotic molecular compound and combinations thereof. In some embodiments, the solid polymeric anolyte layer adjacent the anode and at least one of the further electrolyte layers (which space apart the polymeric anolyte layer from the cathode) each comprise a free ionic liquid.

In some embodiments, each of the further electrolyte layers (which space apart the polymeric anolyte layer from the cathode) comprises an organic electrolyte selected from a free ionic liquid, a polar aprotic molecular compound and combinations thereof. In some embodiments, each of the further electrolyte layers (which space apart the polymeric anolyte layer from the cathode) comprises a free ionic liquid.

In some embodiments, each of the lithium-conductive layers comprises an organic electrolyte selected from a free ionic liquid, a polar aprotic molecular compound and combinations thereof. In some embodiments, each of the lithium-conductive layers comprises a free ionic liquid, optionally the same free ionic liquid.

As used herein, a “free ionic liquid” refers to a low-melting organic salt where neither the cation nor the anion is covalently bonded to a polymeric structure or other solid phase component. It does not imply that the ionic liquid is present in a liquid electrolyte phase, and indeed the free ionic liquid may be blended into the solid matrix of a solid-state electrolyte layer to increase the lithium conductivity thereof. Free ionic liquids may have a melting point of below 100° C., and preferably below room temperature (22° C.), in pure form.

Certain ionic liquids may be particularly preferred liquid organic electrolytes due to their electrochemical stability in the presence of the lithium metal anode and/or the high voltage cathode. In some embodiments, the cation of the free ionic liquid is selected from an ammonium cation, a pyridinium cation, a pyrrolidinium cation, a phosphonium cation, and a combination thereof. Ionic liquids having such cations have been found to promote formation of particularly stable Solid-Electrolyte Interface (SEI) on the surface of a battery anode. Without limitation by theory, this may advantageously assist with the cyclability of the cell since the tendency to form dendrites is reduced, in turn increasing the safety characteristics of the device.

Examples of suitable cations for the free ionic liquid may include N,N-dialkylpyrrolidinium cations such as N-methyl-N-propylpyrrolidinium (Csmpyr) and N-butyl-N-methylpyrrolidinium (C₄mpyr), alkylpyridinium cations such as 3-methyl-1-propylpyridinium, ammonium cations such as N-ethyl-tris(2-(2-methoxyethoxy)ethyl) ammonium (N₂₍₂ₒ₂ₒ₁₎₃), and tetra-alkylphosphonium cations such as trihexyl(tetradecyl)phosphonium (P₆₆₆₁₄), diethyl(methyl)(isobutyl)phosphonium (P₁₂₂ᵢ₄), triisobutyl(methyl)phosphonium (P₁ᵢ₄ᵢ₄ᵢ₄), triethyl(methyl)phosphonium (P₁₂₂₂), trimethyl(isobutyl)phosphonium (P₁₁₁ᵢ₄).

The free ionic liquid may comprise a wide range of anions to balance the charge of the selected cation, provided that they are sufficiently electrochemically stable (e.g. against redox reactions) in the cell. In some embodiments, the free ionic liquid comprises an anion selected from a first group of counter anions consisting of alkyl phosphate, biscarbonate, a sulfonylimide, including e.g. bis(trifluoromethanesulfonyl)imide (TFSI; bistriflimide; N(SO₂CF₃)₂⁻), bis(fluorosulfonyl)imide (FSI; N(SO₂F)₂⁻), fluorosulfonyl-trifluoromethanesulfonyl imide (FTFSI); N(SO₂C₂F₅)₂⁻, N(SO₂CF₃) (SO₂C₄F₉)—, N(SO₂CF₃)(SO₂Ar)⁻ where Ar is an aryl group, N(SO₂CF₃) (SO₂R)⁻ where R is an alkyl group, N(SO₂CF₃)(COCF₃)⁻, and the like, a sulfonylmethide, including e.g. tris(trifluoromethanesulfonyl)methide, a fluorinated alkylsulfonate (RSOs where R is partially fluorinated alkyl, optionally perfluoroalkyl), a fluorinated alkylcarboxylate (RCO₂⁻ where R is partially fluorinated alkyl, optionally perfluoroalkyl), hexasubstituted phosphate (including PF₆⁻, PF₃(CF₃)₃⁻, PF₃(C₂F₅)₃⁻), tetra-substituted borate (including e.g., BF₄⁻, B(CN)₄⁻, optionally fluorinated C₁₋₄ alkyl-BF₃⁻ (including BF₃(CH₃)⁻, BF₃(CF₃)⁻, BF₃(C₂H₅)⁻, BF₃(C₂F₅)⁻, BF₃(C₃F₇)⁻), triflate (OTf, OSO₂CF₃⁻), and a combination thereof. In some preferred embodiments, the free ionic liquid comprises an anion selected from bis(trifluoromethanesulfonyl)imide (TFSI), triflate (OTf), tetrafluoroborate (BF₄), hexafluorophosphate (PF₆), bis(fluorosulfonyl)imide (FSI), fluorosulfonyl-(trifluoromethanesulfonyl)imide (FTFSI), and a combination thereof.

In other embodiments, the organic liquid electrolyte comprises, or consists of, a polar aprotic molecular compound, in particular a polar aprotic solvent (i.e. which is a liquid at room temperature). Examples of suitable polar aprotic molecular compounds include linear ethers, cyclic ethers, esters, carbonates, lactones, nitriles, amides, sulfones, sulfolanes, diethylether, dimethoxyethane, tetrahydrofuran, dioxane, dioxolane, methyltetrahydrofuran, methyl formate, ethyl formate, methyl propionate, propylene carbonate, ethylene carbonate, dimethyl carbonate, diethyl carbonate, ethylmethyl carbonate, dibutyl carbonate, butyrolactones, acetonitrile, benzonitrile, nitromethane, nitrobenzene, dimethylformamide, N-methylpyrolidone, dimethylsulfone, tetramethylene sulfone, sulfolane, thiophene, and a combination thereof.

### Solid Polymeric Anolyte Layer

The rechargeable lithium metal cells disclosed herein include a solid polymeric anolyte layer adjacent the anode, as one of the lithium-conductive layers interposed between the anode and the cathode. The solid polymeric anolyte layer (which may be termed a “first solid polymeric anolyte layer” in embodiments where a “second solid polymeric anolyte layer” is present) comprises: (i) a block copolymer comprising at least one hydrophobic non-ionic block and at least one ionic block; (ii) lithium salt, and optionally (iii) a liquid organic electrolyte. Despite the presence of the lithium salt and any liquid organic electrolyte, the solid polymeric anolyte layer exhibits at least two glass transition temperature (Tg) values.

By “block copolymer” is meant a polymer chain that comprises (i) polymerised monomer residues that provide for a hydrophobic non-ionic block, and (ii) polymerised monomer residues that provide for an ionic block. For example, the block copolymer may be an A-B di-block linear copolymer, where A represents a hydrophobic non-ionic block and B represents an ionic block. The block copolymer may comprise more than two blocks. For example, the block copolymer may be a tri-block copolymer of the form A-B-A, wherein each A is a hydrophobic non-ionic block and B is the ionic block. Suitable block copolymers also include graft copolymers, e.g. where an ionic polymer has pendant hydrophobic polymer chains grafted thereto, provided that the copolymer remains capable of phase separation into hydrobic and hydrophilic domains according to the principles disclosed herein.

The block copolymer may comprise a carbon-chain backbone ( . . . —C—C—C—C—C—C— . . . ), of the type obtained by polymerising ethylenically unsaturated monomers (i.e. monomers where the polymerizable functional group contains a carbon-carbon double bond). Each block of the block copolymer may thus comprise a linear carbon-chain segment of the block copolymer backbone formed by polymerising one or more ethylenically unsaturated monomers suitable to form the required ionic or non-ionic block.

The block copolymer present in the solid polymeric anolyte layer comprises at least one hydrophobic non-ionic block. By the expression “non-ionic block” is meant a polymer block that does not contain ionic charge. In other words, the hydrophobic non-ionic block is a neutral polymer block.

The non-ionic block comprises polymerised residues of hydrophobic monomers. By “hydrophobic monomers” is meant monomers that when homo-polymerised or co-polymerised with each other form polymer that is substantially insoluble in water. In the context of the present invention, the hydrophobic monomers are such that the resultant non-ionic block is sufficiently non-polar to phase-separate from the polar ionic block, thereby providing discrete polymer domains corresponding to the different Tg values of the solid polymeric anolyte layer.

Provided the required hydrophobic character is derived, there is no limitation as to the type of the residues of hydrophobic monomers that can be used for the purpose of the present invention. For example, the residues of hydrophobic monomers may be derived from ethylenically unsaturated monomers such as (meth)acrylate monomer, vinyl ester monomer, styrenic monomer, or combinations thereof. As used herein, the term (meth)acrylate comprises both acrylate and methacrylate.

In some embodiments the residues of hydrophobic monomers are derived from styrene or styrene derivatives, indene or indene derivatives, vinylpyridine or vinylpyridine derivatives, alkyl (meth)acrylate or (meth)acrylate derivatives, vinyl naphthalene or derivatives, or a combination thereof. For example, residues of hydrophobic monomers may be derived from styrene, α-methylstyrene, methylstyrene, chlorostyrene, hydroxystyrene, vinylbenzyl chloride, methylindene, ethylindene, trimethylindene, vinylmethylpyridine, vinylbutylpyridine, vinylquinoline, vinylacrydine, methyl (meth)acrylate, isobornyl (meth)acrylate, adamantyl (meth)acrylate, vinylcarbazole, or a combination thereof. In some preferred embodiments, the residues of hydrophobic monomers are derived from styrene or methyl methacrylate, preferably styrene.

In some embodiments, the hydrophobic non-ionic block comprises a repeating unit having at least one of the following structures (I) and (II):

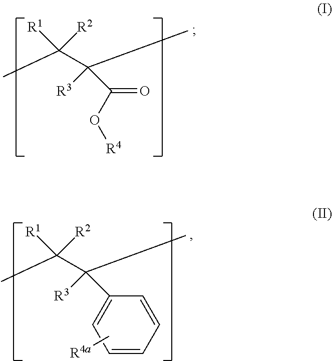

where R¹, R², R³, and R^{4a} are each independently H or C₁₋₆ alkyl, and R⁴ is C₁₋₁₂ alkyl, cycloalkyl or bicycloalkyl. In some embodiments, the repeating unit has structure (I), R¹ and R² are both H, R³ is H or methyl, R⁴ is C₁₋₁₂ alkyl, cycloalkyl or bicycloalkyl. In some embodiments, the repeating unit has structure (II), and each of R¹, R², R³ and R^{4a} are H.

The block copolymer present in the solid polymeric anolyte layer also comprises at least one ionic block. By the expression “ionic block” is meant a polymer block that contains an overall ionic charge, charge-balanced by counterions not covalently bonded to the polymer.

The ionic block may comprise polymerised monomer residues having covalently coupled thereto (a) a pendant organic ionic liquid cation, the pendant organic ionic liquid cation having a counter anion, (b) a pendant anionic moiety, the pendant anionic moiety having a counter cation, or (c) a combination thereof.

The polymerised monomer residues of the ionic block may be derived from ionic monomers having a polymerizable ethylenically unsaturated group such as a (meth)acryloyl, (meth)acryloyloxy, vinyl ester, or styryl group. The polymerised monomer residues of the ionic block may derive from a functionalised styrene, a functionalised indene, a functionalised vinylpyridine, a functionalised (meth)acrylate, a functionalised (meth)acrylamide, or a combination thereof. In each case, the originating monomer is functionalised with a pendant organic ionic liquid cation or a pendant anionic moiety, or a functional group that can be transformed post-polymerization to introduce the pendant organic ionic liquid cation or pendant anionic moiety.

In some embodiments, the ionic block comprises polymerised monomer residues having covalently coupled thereto a pendant organic ionic liquid cation. The type of the pendant organic ionic liquid cation is not particularly limited provided it presents as a pendant moiety to the monomer residues forming the backbone of the ionic block. The pendant organic ionic liquid cation may comprise any known ionic liquid cation type, and in particular organonitrogen and organophosphorous ionic liquid cations. Suitable examples include imidazolium, pyrrolidinium, phosphonium, pyridinium, ammonium, benzimidazolium, pyrrolium, indolium, carbazolium, quinolinium, piperidinium, piperazinium, and sulfonium cations. In some embodiments, the pendant organic ionic liquid cation is selected from imidazolium, pyrrolidinium, phosphonium, pyridinium and ammonium. The cation may be mono-, di-, or tri-substituted, typically alkyl substituted, where each alkyl is independently defined to include C₁₋₈ linear, branched, or cyclic carbon moieties.

In some embodiments, the pendant ionic liquid cation is selected from a 1-alkylene-3-alkyl-imidazolium cation, an N-alkylene-N-alkyl-pyrrolidinium cation, and an alkylene-trialkyl-phosphonium cation, where in each case the cation is covalently coupled to the polymerised monomer residues via the alkylene (i.e. alkanediyl) moiety. In each case, the alkylene may optionally be a C₁-C₁₂ alkylene group, for example a C₁-C₆ alkylene group such as an ethylene (—CH₂CH₂—) group. In each case, the alkyl group (or groups) may (independently) be a C₁-C₁₆ alkyl group, for example a C₁-C₆ alkyl group.

In some embodiments, the pendant organic ionic liquid cation is an imidazolium cation, and in particular a dialkyl imidazolium cation (1,3-dialkyl imidazolium cation) covalently coupled to the polymerised monomer residues of the ionic block via one of the alkyl groups (i.e. the alkyl group acting as linker is properly termed an alkylene group).

Each pendant organic ionic liquid cation in the ionic block will be covalently coupled to the carbon-chain backbone of the ionic block by a linking functional group, the nature of which will depends on the polymerizable ethylenically unsaturated group of the originating monomer. For example, the linking group may be a carboxylate ester (—C[═O]O—; derived from a (meth)acrylate monomer), an amide (—C[═O]NR′— where R′ is C₁₋₆ alkyl or H; derived from an acrylamide monomer) or a benzene-diyl (derived from a styrene monomer).

In some embodiments, the ionic block comprises a repeating unit having the following structure (III):

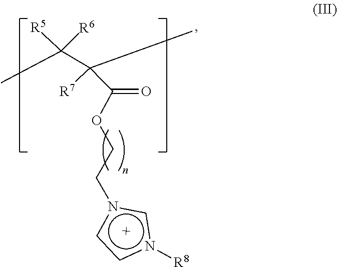

where R⁵, R⁶, R⁷, and R⁸ are each independently H or optionally substituted C₁₋₁₂ alkyl, and n has a value in a range from 0 to about 20, or from 0 to about 10, or from 0 to about 5, such as from 1 to 3, e.g. 1. For example, R⁵ and R⁶ may both be H, R⁷ may be H or methyl, such as H, and R⁸ may be C₁₋₆ alkyl, such as n-butyl, with n between 1 or about 10, such as 1.

The pendant organic ionic liquid cation has a counter anion. A wide range of counter anions are suitable, provided that they neutralize the charge of the pendant organic ionic liquid cation and are sufficiently electrochemically stable (e.g. against redox reactions) in the cell. In some embodiments, the counter anion is a fluorinated anion.

In some embodiments, the counter anion of the pendant organic ionic liquid cation is selected from the first group of counter anions as previously disclosed herein. In some preferred embodiments, the counter anion of the pendant organic ionic liquid cation is selected from bis(trifluoromethanesulfonyl)imide (TFSI), triflate (OTf), tetrafluoroborate (BF₄), hexafluorophosphate (PF₆), bis(fluorosulfonyl)imide (FSI), fluorosulfonyl-trifluoromethanesulfonyl imide (FTFSI), and a combination thereof.

In addition to or instead of the pendant organic ionic liquid cation, the ionic block may comprise polymerised monomer residues having covalently coupled thereto a pendant anionic moiety. The nature of the pendant anionic moiety is not particularly limited provided it presents as a pendant moiety to the monomer residues forming the backbone of the ionic block.

In some embodiments, the pendant anionic moiety comprises a tethered sulfonylimide anion, for example a tethered bis(sulfonyl)imide anion. For example, the ionic block may comprise a repeating unit having the following structure (IV):

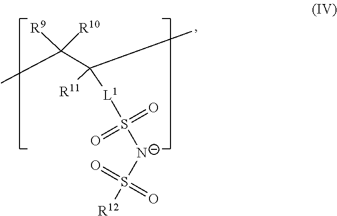

where R⁹, R¹⁰ and R¹¹ are each independently H or optionally substituted C₁₋₁₂ alkyl, L¹ is a bivalent organic linking group, for example para-benzenediyl (1,4-C₆H₄) or alkylene ester (derived from a (methy) acrylate monomer), and R¹² is F or fluorinated C₁₋₃ alkyl (e.g. perfluorinated C₁₋₃ alkyl, such as CF₃). For example, R⁹, R¹⁰ and R¹¹ are H, L¹ is 1,4-C₆H₄ and R¹² is CF₃.

The pendant anionic moiety has a counter cation. Suitably, the counter cation may be lithium.

In one embodiment, the polymerised monomer residues of the ionic block do not have covalently coupled thereto a pendant anionic moiety.

In some embodiments, the block copolymer comprises the following structure (V):

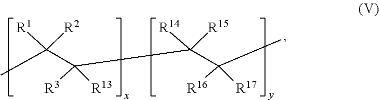

where R¹, R², R³, R¹⁴, R¹⁵ and R¹⁶ are each independently H or C₁₋₆ alkyl, R¹³ is selected from —C(═O)OR⁴ and —C₆H₄R^{4a} where R⁴ is C₁₋₆ alkyl and R^{4a} is H or C₁₋₆ alkyl, R¹⁷ is an ionic substituent comprising a pendant organic ionic liquid cation or a pendant anionic moiety as disclosed herein, and x and y represent the number of polymerised monomer residues in the non-ionic and ionic blocks respectively. For example, x may be in the range of 50 to 500, and y is in the range of 15 to 200.

In some embodiments, R¹, R², R¹⁴ and R¹⁵ are each H, and R³ and R¹⁶ are each independently H or methyl. In these or other embodiments, R¹³ may be phenyl. In these or other embodiments, R¹⁷ may comprise a dialkyl-imidazolium group covalently coupled to the polymer chain via one of its alkyl groups.

In some embodiments, the block copolymer comprises the following structure (Va):

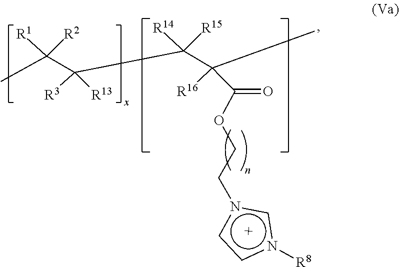

where R¹, R², R³, R¹³, R¹⁴, R¹⁵, R¹⁶, x and y are as defined for structure (V), n has a value in a range from 0 to about 20, or from 0 to about 10, or from 0 to about 5, such as from 1 to 3, and R⁸ is H or optionally substituted C₁₋₆ alkyl, such as n-butyl.

The block copolymer may have a molecular weight across a wide range, including a molecular weight of below 40,000 g/mol. However, in some embodiments the molecular weight of the block copolymer is greater than 50,000 g/mol, for example greater than 100,000 g/mol. Reference herein to the molecular weight of a polymer is intended to mean that as determined by either gel permeation chromatography (GPC) or ¹H NMR. In some embodiments, the molecular weight of at least one hydrophobic non-ionic block of the block copolymer is greater than 18,000 g/mol, for example greater than 25,000 g/mol. In some embodiments, the at least one hydrophobic non-ionic block of the block copolymer comprises polymerised residues of at least 170 monomers, for example at least 240 monomers.

Without wishing to be limited by any theory, it is believed that high molecular weight block copolymers, and particularly those having high molecular weight non-ionic blocks, may have favourable mechanical properties which allow the polymeric anolyte layer to be produced as a robust and continuous thin film adjacent the anode. It is preferable that the non-ionic hydrophobic block segments are of high molecular weight, specifically above their chain entanglement molecular weight, a point known to those skilled in the art as being where polymer chains begin to entangle on a molecular level resulting in a significant increase in bulk mechanical strength properties. For example, polystyrene has a chain entanglement molecular weight of about 18,000 g/mol. It is therefore preferable that where polystyrene is used as the non-ionic blocks, such as in A-B-A triblock copolymers, that its molecular weight is above 18,000 g/mol, and more preferably above 21,000 g/mol.

In some embodiments, the block copolymer is a tri-block copolymer of the form A-B-A, wherein each A is a hydrophobic non-ionic block and B is the ionic block. Incompatibility between the A and B blocks leads to a phase-separated morphology in the bulk solid state. Without wishing to be limited by any theory, it is proposed that the triblock structure may allow a single polymer molecule to span three adjacent domains in the bulk solid polymer structure, with the two non-ionic blocks present in different hydrophobic domains and the polymerized ionic liquid block in the intermediate hydrophilic domain bridging the two disconnected hydrophobic A domains. This bridging is an important feature of A-B-A-type thermoplastic elastomers providing significant improvements to bulk mechanical properties over A-B-type block copolymers.

The block copolymer may be prepared by any suitable means. In some embodiments, the block copolymer is prepared by a process comprising the polymerisation of ethylenically unsaturated monomers. The polymerisation of the ethylenically unsaturated monomers is preferably conducted using a living polymerisation technique. Examples of living polymerisation include ionic polymerisation and controlled radical polymerisation (CRP). Examples of CRP include, but are not limited to, iniferter polymerisation, stable free radical mediated polymerisation (SFRP), atom transfer radical polymerisation (ATRP), and reversible addition fragmentation chain transfer (RAFT) polymerisation.

In some embodiments, the block copolymer is formed by polymerising ethylenically unsaturated monomer under the control of a living polymerisation agent, for example a RAFT agent. Non-limiting examples of RAFT agents suitable for use in accordance with the invention may be obtained commercially, for example see those described in the Sigma Aldrich catalogue (www.sigmaaldrich.com), or Boron Molecular catalogue (www.boronmolecular.com).

When a living polymerisation agent, such as a RAFT agent is used, it will be appreciated that the block copolymer may include residue functionalities of the living polymerisation agent, for example at the termini of the polymer chain, e.g. as the chain termini functional groups of structures (V) and (Va), or as a linker between adjacent hydrophobic non-ionic and ionic blocks.

The solid polymeric anolyte layer comprises lithium salt. The lithium cations of the lithium salt are charge balanced by anions which are not covalently coupled to the block copolymer. Thus, the lithium salt is additional to any lithium cations present as counterions to pendant anionic moieties of the ionic block. Solid state electrolytes comprising anionic polymers are insufficiently conductive of lithium if the only source of lithium present in the electrolyte is the lithium which balances the charge of immobilised anionic moieties on the polymer.

Aside from this, there is no particular limitation as to the type of the lithium salt that may be used, provided that salt is chemically compatible with the other components of the composition and that the anion is sufficiently electrochemically stable (e.g. against redox reactions) in the cell. In some embodiments, the lithium salt is selected from lithium bis(trifluoromethanesulfonyl)imide (Li-TFSI), lithium bis(fluorosulfonyl)imide (Li-FSI), lithium fluorosulfonyl-trifluoromethanesulfonyl imide (Li-FTFSI), lithium tris(trifluoromethanesulfonyl)methide, lithium tetrakis(3,5-bis(trifluoromethyl)-2,4,6-trifluoro-phenyl)borate (Li[C₆F₃(CF₃)₂]₄), lithium triflate (LiOTf), lithium tetrafluoroborate (LiBF₄), lithium hexafluorophosphate (LiPF₆), LiCₙF₂ₙ₊₁SO₃— where n is an integer from 1 to 10, LiCₙF₂ₙ₊₁CO₂— where n is an integer from 1 to 10, and a combination thereof.

In some embodiments where the ionic block comprises polymerised monomer residues having covalently coupled thereto a pendant organic ionic liquid cation, the anion of the lithium salt is the same as the counter anion to the pendant organic ionic liquid cation.

The lithium salt is present in the solid polymeric anolyte layer in an amount sufficient to provide good ionic conductivity, and in particular facile lithium transport between the cathode and anode during cycling of the cell. In some embodiments, the solid polymeric anolyte layer comprises the lithium salt in an amount of at least 10 wt. %. For example, the amount of lithium salt may be between about 10 wt. % and about 50 wt. %, such as between about 20 wt. % and about 35 wt. %, relative to the total weight of the solid polymeric anolyte layer.

In preferred embodiments, the solid polymeric anolyte layer further comprises an organic electrolyte, which is not covalently coupled to the block copolymer. The organic electrolyte is typically a liquid at room temperature (in the absence of other components such as the block copolymer) and is able to solubilise the lithium salt. Thus, the organic electrolyte facilitates lithium conductivity through the solid polymeric anolyte layer and across the interface between the solid polymeric anolyte layer and the adjacent lithium-conductive layer during charging and discharging of the cell. However, the amount of organic electrolyte is limited by the imperative to avoid dissolving or excessively plasticising the block copolymer, which would undesirably degrade its polymeric solid structure as evident from the two glass transition temperature (Tg) values.

In some embodiments, therefore, the solid polymeric anolyte layer comprises the organic electrolyte in an amount of less than 50 wt. %. For example, the amount of organic electrolyte may be between about 1 wt. % and about 50 wt. %, such as between about 5 wt. % and about 35 wt. %, or between about 10 wt. % and about 30 wt. %, relative to the total weight of the solid polymeric anolyte layer. In such ranges the organic electrolyte may provide an advantageous balance between high ionic conductivity and mechanical stability of the solid polymeric anolyte layer.

In some embodiments, the organic electrolyte is selected from a free ionic liquid, a polar aprotic molecular compound and combinations thereof. In some embodiments, the organic electrolyte comprises, or consists of, free ionic liquid.

In some embodiments, the cation of the free ionic liquid is selected from an ammonium cation, a pyridinium cation, a pyrrolidinium cation, a phosphonium cation, and a combination thereof. Ionic liquids having such cations have been found to promote formation of particularly stable Solid-Electrolyte Interface (SEI) on the surface of a battery anode. Without limitation by theory, this may advantageously assist with the cyclability of the cell since the tendency to form dendrites is reduced, in turn increasing the safety characteristics of the device.

Examples of suitable cations for the free ionic liquid include N,N-dialkylpyrrolidinium cations such as N-methyl-N-propylpyrrolidinium (C₃mpyr) and N-butyl-N-methylpyrrolidinium (C₄mpyr), alkylpyridinium cations such as 3-methyl-1-propylpyridinium, ammonium cations such as N-ethyl-tris(2-(2-methoxyethoxy)ethyl) ammonium (N₂₍₂ₒ₂ₒ₁₎₃), and tetra-alkylphosphonium cations such as trihexyl(tetradecyl)phosphonium (P₆₆₆₁₄), diethyl(methyl)(isobutyl)phosphonium (P₁₂₂ᵢ₄), triisobutyl(methyl)phosphonium (P₁ᵢ₄ᵢ₄ᵢ₄), triethyl(methyl)phosphonium (P₁₂₂₂), trimethyl(isobutyl)phosphonium (P₁₁₁ᵢ₄).

The free ionic liquid may comprise a wide range of anions to balance the charge of the selected cation, provided that they are sufficiently electrochemically stable (e.g. against redox reactions) in the cell. In embodiments where the ionic block of the block copolymer comprises polymerised monomer residues having covalently coupled thereto a pendant organic ionic liquid cation, the anion may be the same as or different to the counter anion of the pendant organic ionic liquid cation. The anion of the free ionic liquid may also be the same as or different to the anion of the lithium salt. In some embodiments, the anion of the free ionic liquid is a fluorinated anion.

In some embodiments, the free ionic liquid comprises an anion selected from the first group of counter anions as previously disclosed herein. In some preferred embodiments, the free ionic liquid comprises an anion selected from bis(trifluoromethanesulfonyl)imide (TFSI), triflate (OTf), tetrafluoroborate (BF₄), hexafluorophosphate (PF₆), bis(fluorosulfonyl)imide (FSI), fluorosulfonyl-(trifluoromethanesulfonyl)imide (FTFSI), and a combination thereof.

In some embodiments, the organic electrolyte comprises, or consists of, a polar aprotic molecular compound, in particular a polar aprotic solvent (i.e. which is a liquid at room temperature). Examples of suitable polar aprotic molecular compounds include linear ethers, cyclic ethers, esters, carbonates, lactones, nitriles, amides, sulfones, sulfolanes, diethylether, dimethoxyethane, tetrahydrofuran, dioxane, dioxolane, methyltetrahydrofuran, methyl formate, ethyl formate, methyl propionate, propylene carbonate, ethylene carbonate, dimethyl carbonate, diethyl carbonate, ethylmethyl carbonate, dibutyl carbonate, butyrolactones, acetonitrile, benzonitrile, nitromethane, nitrobenzene, dimethylformamide, N-methylpyrolidone, dimethylsulfone, tetramethylene sulfone, sulfolane, thiophene, and a combination thereof.

Despite the presence of the lithium salt and any organic electrolyte, the solid polymeric anolyte layer remains a solid-state electrolyte and exhibits at least two glass transition temperature (Tg) values corresponding to different solid phases of the block copolymer.

Advantageously, the solid polymeric anolyte layer is a solid at nominal operational conditions of the rechargeable lithium metal cell. For example, the solid polymeric anolyte layer may be a solid at least at room temperature, for example at about 20° C. In some embodiments, the solid polymeric anolyte layer is a solid at least up to about 30° C., about 50° C., about 70° C., or about 80° C. For example, the solid polymeric anolyte layer may be a solid at a temperature of at least up to 100° C.

The “Tg”, or glass transition temperature, is a temperature value representative of a temperature or temperature range over which an amorphous polymeric composition (or the amorphous regions in a partially crystalline polymeric composition) changes from a relatively hard and brittle state to a relatively viscous or rubbery state.

In the context of the present invention the number of Tg values for a given composition is determined by differential scanning calorimetry (DSC). A skilled person would be aware of procedures for the determination of the number of Tg values of a sample based on DSC characterisation. For example, a Tg value of a composition may be defined by a stepwise increase of the heat capacity as a function of temperature. Presence of a Tg value is determined by either the onset temperature (i.e. start point or end point) or inflection point (i.e. mid-point). A skilled person would know how to analyse such curve and identify the number of discontinuities corresponding to the number of Tg values. For example, Tg values may be determined according to ASTM E1356-08 “Standard Test Method for Assignment of the Glass Transition temperatures by Differential Scanning calorimetry”.

As used herein, the Tg of the solid polymeric anolyte layer is intended to mean that obtained by DSC analysis performed on the composition of that layer per se (i.e. including the block copolymer, lithium salt and any organic electrolyte). It is nevertheless believed the measured Tg of the composition reflects the Tg of the copolymer in that composition. The Tg profile of the composition may however differ from the Tg profile of the copolymer due to possible plasticising effects on the copolymer deriving from the lithium salt and/or the organic electrolyte present in the composition in addition to the copolymer.

The at least two Tg values of the solid polymeric anolyte layer is characteristic of its morphology having micro-phase separation. Without wanting to be confined by theory, such morphology is believed to be beneficial to both the ionic conductivity and the mechanical properties of the composition. For example, it is believed a solid state electrolyte morphology characterised by micro-phase separation ensures preferential pathways for ionic diffusion, thus promoting ionic conductivity. On the other hand, it is believed that such micro-phase separation emphasises the composite-like character of the composition, thus improving its overall mechanical properties.

As used herein the expression “micro-phase separation” of the composition is intended to mean the presence or formation of nanometer-sized structures derived from the spatial self-assembly of the composition constituents. Without being confined to theory, such self-assembled structures are believed to form a periodic nanostructured morphology with connected ion-conducting domains. Where the electrolyte composition presents micro-phase separation at least one region of nanophase separation may be characterized by a periodic nanostructured lamellar, spherical, hexagonal, 3D continuous or discontinuous morphology. Those domains may extend in one-, two- or three-dimensions throughout the composition. The periodicity of the nanostructured morphology may be characterized by ordered domains having lattice parameter dimensions in the range of about 1 nm to about 500 nm, as measured by small angle X-ray scattering (SAXS).

The Tg of the solid polymeric anolyte layer associated with the hydrophobic non-ionic block of the copolymer is not limited to any specific value. For example, the Tg associated with the non-ionic block may be between about 40° C. and about 250° C., between about 40° C. and about 200° C., between about 40° C. and about 175° C., between about 40° C. and about 150° C., between about 40° C. and about 125° C., between about 40° C. and about 100° C., between about 50° C. and about 100° C., between about 60° C. and about 100° C., or between about 70° C. and about 100° C.

Similarly, the Tg of the solid polymeric anolyte layer associated with the ionic block of the copolymer is not limited to any specific value. For example, the Tg associated with the ionic block may be between about −100° C. and about 50° C., between, between about −100° C. and about 20° C., between about −100° C. and about 0° C., between about −100° C. and about −30° C., between about −100° C. and about −70° C., or between about −100° C. and about −90° C.

The solid polymeric anolyte layer is adjacent the anode, and thus directly in contact with the metallic lithium of the anode. The solid polymeric anolyte layer is preferably a continuous film which covers the entire anode surface. With such a configuration, the solid polymeric anolyte layer will mediate the transport of lithium ions from the anode to the cathode during discharge and from the cathode to the anode during charging. Without wishing to be limited by any theory, the solid polymeric anolyte layer may thus inhibit dendrite formation as lithium is electroplated on the anode during charging, and may also protect the electrolytes and anode from undesirable and potentially hazardous reactions in extended use or if the cell is physically damaged.

In some embodiments, the solid polymeric anolyte layer may have a thickness of less than 50 μm, preferably less than 20 μm, such as between 0.5 and 20 μm, or between 1 and 10 μm. Surprisingly, such thin anolyte layers have been found sufficient to stabilise the lithium metal anode over extended cycling of the cell when used in combination with one or more further electrolyte layers which space apart the solid polymeric anolyte layer from the cathode.

The solid polymeric anolyte layer may be positioned adjacent to the anode by any method. In some embodiments, the solid polymeric anolyte layer is produced on the anode as a coating. It is not excluded that the solid polymeric anolyte layer may be cast onto a suitable mould or other substrate to form a film which is subsequently transferred onto the anode surface. However, pre-formed films of the preferred thickness (such as less than 20 μm) are not readily transferrable onto the anode.

### Second Polymeric Anolyte Layer

In some embodiments, the cell includes a second polymeric anolyte layer comprising a block copolymer as disclosed herein, lithium salt and optionally an organic electrolyte, and having at least two glass transition temperature (Tg) values. Optionally, the second polymeric anolyte layer may have the same composition as the solid polymeric anolyte layer. The second polymeric anolyte layer is located adjacent to the first solid polymeric anolyte layer but is still spaced apart from the cathode by one or more further electrolyte layers. Advantageously, the second solid polymeric electrolyte may cover any pinholes or other defects present in the first solid polymeric anolyte layer, thus ensuring that all lithium ion transport to and from the anode passes through a solid state polymeric layer comprising the block copolymer.

Schematically depicted in FIG. 2 is a rechargeable lithium metal cell 200 according to one such embodiment. Numbered items of cell 200 are generally as described herein for cell 100 with reference to FIG. 1. However, cell 200 comprises, as one of the further electrolyte layers 114, second polymeric anolyte layer 212 located adjacent to (first) solid polymeric anolyte layer 112. Second polymeric anolyte layer 212 comprises a block copolymer as disclosed herein, lithium salt and optionally an organic electrolyte, and has at least two glass transition temperature (Tg) values. Indeed, layer 212 may have the same composition as solid polymeric anolyte layer 112. Layer 212 is spaced apart from cathode 104 by one or more of the further electrolyte layers 114—represented in FIG. 2 as electrolyte layer 214. Electrolyte layer 214 may suitably include one or more solid state electrolyte layers including a solid polymeric catholyte layer, as will be described hereafter.

The presence of two similar or identical block copolymer-based solid electrolyte layers, such as layers 112 and 212, may facilitate the fabrication of the cell. During the fabrication, an anode half-cell comprising the solid polymeric anolyte layer adhered to the anode may be produced. For example, the anode half-cell comprises anodic current collector 106, lithium metal anode 102 and solid polymeric anolyte layer 112. Separately, a cathode half-cell comprising the cathode, one or more further electrolyte layers and the second polymeric anolyte layer at the outer surface may be produced. For example, the cathode half-cell comprises cathodic current collector 108, one or more further electrolyte layers 114 and second polymeric anolyte layer 212. The cell may then be fabricated by assembling the anode half-cell and cathode half-cell and bonding the solid polymeric anolyte layer (e.g. layer 112) to the second polymeric anolyte layer (e.g. layer 212). Advantageously, the resultant cell is mechanically robust and has excellent lithium transport properties across the newly formed interface between the two half-cell components because of the bonding between the two similar, or identical, solid polymeric electrolyte layers.

### Solid Catholyte Layer

In some embodiments, the rechargeable lithium metal cells disclosed herein include a solid catholyte layer adjacent the cathode as one of the further electrolyte layer(s) which space apart the solid polymeric anolyte layer from the cathode. The solid catholyte layer is preferably an oxidation-resistant electrolyte layer which is capable of withstanding exposure to the highly oxidising environment adjacent the cathode when cycling the cell. The solid catholyte layer may be selected from a solid polymeric catholyte layer and a solid inorganic electrolyte layer.

In some embodiments, the solid catholyte layer comprises a lithium-containing inorganic material comprising mobile lithium ions, such as a garnet, a NASICON-type material, a sulfide or a perovskite. Suitable lithium-ion conductivity between the solid catholyte layer and the cathode (overcoming the interfacial resistance at the grain boundary between two layers comprising particulate inorganic materials) may be ensured by (i) high pressure application of the inorganic material comprising mobile lithium ions to the cathode, and/or (ii) the use of an organic electrolyte additive (as disclosed herein) to the solid catholyte layer.

### Solid Polymeric Catholyte Layer

In some embodiments, the rechargeable lithium metal cells disclosed herein include a solid polymeric catholyte layer adjacent the cathode, as one of the further electrolyte layer(s) which space apart the solid polymeric anolyte layer from the cathode.

The solid polymeric catholyte layer preferably comprises lithium salt, thereby providing mobile lithium ions to facilitate lithium ion transport between the anode and cathode during discharge and charging of the cell. The lithium cations of the lithium salt are charge balanced by anions which are not covalently coupled to the polymer matrix of the solid polymeric catholyte layer. Aside from this, there is no particular limitation as to the type of the lithium salt that may be used, provided that salt is chemically compatible with the other components of the composition and the anions are sufficiently electrochemically stable (e.g. against redox reactions) in the cell. The lithium salt may be the same or different as the lithium salt in the solid polymeric anolyte layer. In some embodiments, it is the same salt. In some embodiments, the lithium salt is selected from lithium bis(trifluoromethanesulfonyl)imide (Li-TFSI), lithium bis(fluorosulfonyl)imide (Li-FSI), lithium fluorosulfonyl-trifluoromethanesulfonyl imide (Li-FTFSI), lithium tris(trifluoromethanesulfonyl)methide, lithium tetrakis(3,5-bis(trifluoromethyl)-2,4,6-trifluoro-phenyl)borate (Li[C₆F₃(CF₃)₂]₄), lithium triflate (LiOTf), lithium tetrafluoroborate (LiBF₄), lithium hexafluorophosphate (LiPF₆), LiCₙF₂ₙ₊₁SO₃⁻ where n is an integer from 1 to 10, LiCₙF₂ₙ₊₁CO₂⁻ where n is an integer from 1 to 10, and a combination thereof.

The lithium salt is present in the solid polymeric catholyte layer in an amount sufficient to provide good ionic conductivity, and in particular facile lithium transport between the cathode and anode during cycling of the cell. In some embodiments, the solid polymeric catholyte layer comprises the lithium salt in an amount of at least 10 wt. %. For example, the amount of lithium salt may be between about 10 wt. % and about 30 wt. % relative to the total weight of the solid polymeric anolyte layer.

Due to its proximity to the high-voltage cathode material, the solid polymeric catholyte layer preferably comprises an oxidation-stable polymeric matrix.

In some embodiments, the solid polymeric catholyte layer comprises a fluorinated polymer, in particular a fluorinated polymer comprising a carbon-chain backbone ( . . . —C—C—C—C—C—C— . . . ). The carbon atoms of the backbone are thus at least partially fluorine-substituted. In some embodiments, the fluorinated polymer is an ionic polymer. Preferably, the ionic fluorinated polymer comprises pendant ionic groups, for example cationic groups, covalently coupled to the carbon-chain backbone. In some embodiments, the pendant ionic groups comprise one or more organic ionic liquid cations, and preferably each pendant ionic group comprises a plurality of organic ionic liquid cations.

The organic ionic liquid cation(s) present in the pendant ionic groups may comprise any known ionic liquid cation type. Suitable examples include quaternary ammonium, imidazolium, benzimidazolium, pyrrolidinium, pyrrolium, indolium, carbazolium, pyridinium, quinolinium, piperidinium, piperazinium, phosphonium and sulfonium cations. The cation(s) may be mono-, di-, or tri-substituted, typically alkyl substituted, where each alkyl is independently defined to include C₁₋₈ linear, branched, or cyclic carbon moieties.

In some embodiments, the organic ionic liquid cation(s) present in the pendant ionic groups are quaternary ammonium groups, and in particular tetra-alkyl quaternary ammonium groups which are covalently coupled to the remainder of the pendant ionic group via one of the alkyl groups (the alkyl group acting as linker may properly be termed an alkylene group).

In some embodiments, the fluorinated polymer comprises a repeating unit having the following structure (VI):

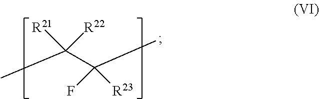

where R²¹ and R²² are each independently a hydrogen atom (H) or a fluorine atom (F) and R²³ is a pendant ionic group comprising one or more organic ionic liquid cations, and preferably a plurality of organic ionic liquid cations. In some embodiments, R²¹ and R²² are both H.

R²³ may be a pendant ionic group comprising a plurality of organic ionic liquid cations selected from quaternary ammonium, imidazolium, benzimidazolium, pyrrolidinium, pyrrolium, indolium, carbazolium, pyridinium, quinolinium, piperidinium, piperazinium, phosphonium and sulfonium cations. In some embodiments, the ionic liquid cations are quaternary ammonium cations.

In some embodiments, the fluorinated polymer comprises the following structure (VII):

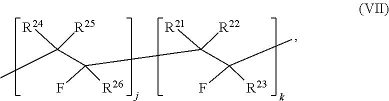

where R²¹, R²² and R²³ are as defined above, R²⁴, R²⁵ and R²⁶ are each independently H or F, j is from 65 to 99 mol % and k is from 1 to 35 mol % where j+k=100 mol %. In some embodiments, j is from 67 to 97 mol % and k is from 3 to 33 mol %. In some embodiments, j is from 70 to 90 mol % and k is from 10 to 30 mol %. In some embodiments, R²¹, R²², R²⁴, R²⁵ are each H and R²⁶ is F. Thus, the fluorinated polymer may be considered as a PVDF-based polymer having pendant ionic groups grafted thereto. The fluorinated polymer, for example when having structure (VII), may be a block copolymer or random copolymer.

The pendant ionic groups, for example R²³ in structures (VI) and (VII), may be an oligomer or polymer comprising polymerised monomer residues having covalently coupled thereto an organic ionic liquid cation. The polymerised monomer residues may derive from ionic monomers that comprise a pendant organic ionic liquid cation of the kind described herein. There is no particular limitation as to the type of such monomers, provided they comprise a polymerizable moiety and an organic ionic liquid cation. In some embodiments, the polymerizable moiety is an ethylenically unsaturated functional group, such as a (meth)acryloyl, (meth)acryloyloxy, vinyl ester, or styryl group. Non-limiting classes of such monomers include (meth)acryloyloxy-ammonium, (meth)acryloyloxy-imidazolium, (meth)acryloyloxy-pyrrolidinium and (meth)acryloyloxy-pyridinium monomers. In other embodiments, the polymerizable moiety is an epoxy functional group, such as a glycidyl group.

Non-limiting examples of suitable ionic monomers include trialkylaminoalkyl (meth)acrylate (e.g. trimethylaminoethyl methacrylate or trimethylaminoethyl acrylate), trialkylaminoalkyl acrylamido (e.g. trimethylaminopropyl acrylamido), 1-alkyl-3-vinyl imidazolium, 4-vinyl-1-alkylpyridinium, 1-(4-vinylbenzyl))-3-alkyl imidazolium, 2-(methacryloyloxy) dialkyl ammonium, 1-(vinyl oxyethyl)-3-alkylimidazolium, 1-vinyl imidazolium, 1-allylimidazolium, N-alkyl-N-allyl ammonium, 1-vinyl-3-alkylimidazolium, 1-glycidyl-3-alkyl-imidazolium, N-allyl-N-alkyl pyrrolidinium, N-vinyl-carbazolium, or quaternary diallyl dialkyl ammonium cations. In these examples, each alkyl may independently be a C₁₋₁₀ alkyl group.

The pendant ionic groups may be covalently coupled to the carbon-chain backbone of the fluorinated polymer by any suitable means. In some preferred embodiments the pendant ionic groups are produced by graft polymerisation (the term including graft oligomerisation) of the ionic monomers directly onto the carbon-chain backbone of the fluorinated polymer. Here, the ionic monomer comprises a pendant organic ionic liquid cation and a polymerizable functional group, for example an ethylenically unsaturated functional group. The ionic monomers are preferably the only monomers present in the pendant ionic groups, but it is not excluded that the ionic monomers and other, non-ionic monomers may be copolymerised to form pendant ionic groups grafted to the carbon-chain backbone of the fluorinated polymer.

In some embodiments, the graft polymerisation is conducted by atom transfer radical polymerisation (ATRP) using transition metal catalysts. A suitable starting material for graft polymerisation using ATRP is (i) a fluorinated polymer comprising a repeating unit having the structure (VI) as defined above except that R²³ is a non-fluorine halide, or (ii) a fluorinated polymer comprising the structure (VII) as defined above except that R²³ is a non-fluorine halide. In either case, R²³ may be chloride (Cl), bromide (Br) or iodide (I), suitably Cl. The carbon-halide bond is readily activated for monomer insertion in ATRP polymerization due to the presence of fluorine groups on the polymer backbone. Transition metals catalysts for ATRP are known to the skilled person. For example, the catalyst may be a copper complex such as a complex of copper (I) chloride (CuCl) and 4,4′-dimethyl-2,2′-bipyridyl (bpy). Suitable reaction solvents for ATRP graft polymerisation include N-methylpyrrolidone, dimethylacetamide, dimethyl sulfoxide, acetone and the like.

The ionic monomers may be grafted onto the carbon-chain backbone of the fluorinated polymer in an amount of 3 to 85 mol %, preferably 40 to 85 mol % (based on total monomers in the polymer).

In some embodiments, the fluorinated polymer comprises a repeating unit having the following structure (Via):

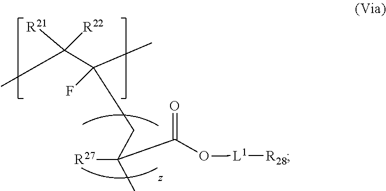

where R²¹ and R²² are as defined above each for structure (VI), R²⁷ is H or methyl, z refers to the number of ionic monomers present in the pendant ionic group, typically defined by the extent of graft polymerization, L¹ is a bivalent linker, for example a C₁₋₁₂ alkylene, and R²⁸ is an organic ionic liquid cation.

In some embodiments, the fluorinated polymer comprises a repeating unit having the following structure (Vib):

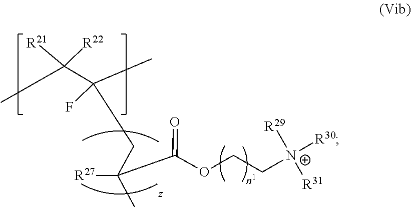

where R²¹, R²², R²⁷ and z are as defined for structure (Via), n¹ has a value in a range from 0 to about 20, or from 0 to about 10, or from 0 to about 5, such as from 1 to 3, e.g. 1, and R²⁹, R³⁰ and R³¹ are each independently optionally substituted C₁₋₁₂ alkyl, such as C₁₋₆ alkyl, for example methyl.

The pendant ionic groups, for example R²³ in structures (VI) and (VII), comprise one or more counter anions to balance the charge of the one or more organic ionic liquid cations. A wide range of counter anions are suitable, provided that they neutralize the charge of the organic ionic liquid cations and are sufficiently electrochemically stable (e.g. against redox reactions) in the cell. Preferably, the counter anion is a fluorinated counter anion.

In some embodiments, the counter anion(s) of the pendant ionic groups are selected from the first group of counter anions as previously disclosed herein. In some preferred embodiments, the counter anion(s) of the pendant ionic groups are selected from bis(trifluoromethanesulfonyl)imide (TFSI), triflate (Otf), tetrafluoroborate (BF₄), hexafluorophosphate (PF₆), bis(fluorosulfonyl)imide (FSI), fluorosulfonyl-(trifluoromethanesulfonyl)imide (FTFSI), and a combination thereof.

The counter anion(s) of the pendant ionic groups may be the same as or different to the anions of the lithium salt present in the solid polymeric catholyte layer. The counter anions may also be the same as or different to any of the anions present in the solid polymeric anolyte layer (e.g. from the lithium salt, any free ionic liquid electrolyte and/or any counter anions to the ionic block).

The molecular weight of the fluorinated polymer may be in the range of 30,000 to 2,000,000 g/mol, for example 100,000 to 1,500,000 g/mol. The mean molecular weight may be calculated based on the intrinsic viscosity [η] in an estimated formula.

In some embodiments, the solid polymeric catholyte layer comprises an organic electrolyte, selected from a free ionic liquid, a polar aprotic molecular compound and combinations thereof, as previously disclosed herein.

In some embodiments, the solid polymeric catholyte layer comprises a free ionic liquid. In some embodiments, the cation of the free ionic liquid is selected from an ammonium cation, a pyridinium cation, a pyrrolidinium cation, a phosphonium cation, and a combination thereof. In some embodiments, the anion of the free ionic liquid is a fluorinated anion. Nonlimiting examples of suitable free ionic liquids include 3-methyl-1-propylpyridinium bis(fluorosulfonyl)imide, 1-butyl-1-methylpyrolidinium bis(fluorosulfonyl)imide and the equivalent bis(trifluoromethanesulfonyl)imide salts.

In some embodiments, the solid polymeric catholyte layer comprises a lithium salt in combination with a polymer capable of solubilizing the lithium salt. Suitably, the polymer is a poly(alkylene oxide), such as polyethylene oxide. In some embodiments, the polymer is present as a second polymer in combination with a fluorinated polymer. The fluorinated polymer may be ionic or non-ionic, for example a non-ionic fluorinated polymer, such as polyvinylidene fluoride co-hexafluoropropylene. Non-limiting examples of compositions for such solid polymeric catholyte layers comprising first and second polymers are disclosed in US2009/0162754A1.

In some embodiments, the solid polymeric catholyte layer comprises another ionic additive selected from (i) a monomer comprising an ionic liquid cation and (ii) a polymer or copolymer thereof. Here, the monomer comprising an ionic liquid cation may be of the type described herein in the context of the ionic monomers used in the graft polymerisation reactions.

Despite the presence of the lithium salt, any free ionic liquid or other liquid organic electrolyte, any second polymer and any other additives, the solid polymeric catholyte layer remains a solid-state electrolyte. It may thus be a solid at least at room temperature, for example at about 20° C. In some embodiments, the solid polymeric catholyte layer is a solid at least up to about 30° C., about 50° C., about 70° C., or about 80° C. For example, the solid polymeric catholyte layer may be a solid at a temperature of at least up to 100° C.

The solid polymeric catholyte layer is adjacent the cathode, and may thus be directly in contact with the high-voltage cathode material of the cathode. Advantageously, solid polymeric catholyte layers as disclosed herein have been found to be highly stable against oxidation by high-voltage cathode materials, while providing excellent lithium conductivity from the anode to the cathode during discharge and from the cathode to the anode during charging.

The solid polymeric catholyte layer is preferably a continuous film which covers the entire cathode surface. However, it should be appreciated that the solid polymeric catholyte layer and cathode need not be entirely discrete layers meeting at a planar interface. In some embodiments, the polymer-based composition of the solid polymeric catholyte layer is integrated into the porosity of the cathode. The integration of the solid polymeric catholyte layer with the cathode may advantageously assist to facilitate lithium ion transport to and from the high-voltage cathode material throughout the cathode structure. Nevertheless, the solid polymeric catholyte layer forms a spacer layer between the cathode, and in particular the particulate high-voltage cathode material in the cathode, and the solid polymeric anolyte layer.

The solid polymeric catholyte layer may have a thickness of less than 50 μm, preferably less than 20 μm, such as between 0.5 and 20 μm, or between 1 and 10 μm, above the cathode surface. The solid polymeric anolyte layer is thus spaced apart from the cathode by at least the thickness of this layer. Surprisingly, such thin catholyte layers have been found sufficient to compatibilise the high-voltage cathode with other electrolyte layers of the cell, including the solid polymeric anolyte layer.

The solid polymeric catholyte layer may be positioned adjacent to the cathode by any method. For example, the solid polymeric catholyte layer may be cast onto a suitable mould or other substrate to form a film which is subsequently transferred onto the cathode surface. However, in some embodiments a catholyte composition is applied as a precursor fluid to the cathode so as to infiltrate the porous structure of the cathode. In this case, sufficient catholyte composition is applied so as to infiltrate the porous cathode and to form a continuous overlying film on the surface of the cathode. Subsequent drying and/or curing of the catholyte composition forms the solid polymeric catholyte layer on the cathode.

### Intermediate Electrolyte Layer

In some embodiments, the cell includes an intermediate electrolyte layer interposed between the solid catholyte layer (e.g. the solid polymeric catholyte layer as disclosed herein) and the solid polymeric anolyte layer. The intermediate electrolyte layer may be selected from a solid polymeric electrolyte layer, a solid inorganic electrolyte layer and a liquid electrolyte layer. The intermediate electrolyte layer may facilitate lithium ion conduction between the solid catholyte layer and the solid polymeric anolyte layer (and thus between cathode and anode) in use. Without limitation by any theory, the intermediate electrolyte layer may (i) assist to compatibilise the solid catholyte layer and the solid polymeric anolyte layer by reducing the interfacial resistance that would exist if these layers were directly adjacent, thus reducing the internal resistance in the cell; (ii) provide a reservoir of lithium salt to supplement lithium salt present in the solid catholyte layer and the solid polymeric anolyte layer (which in preferred embodiments are very thin layers, e.g. <20 μm); and/or (iii) provide a minimum spacing distance between the solid polymeric anolyte layer and the cathode.

In some embodiments, the intermediate electrolyte layer is a solid polymeric electrolyte layer. The intermediate solid polymeric electrolyte layer may comprise a conductive polymeric composition comprising a fluorinated polymer, preferably a fluorinated polymer comprising pendant ionic groups covalently coupled to the carbon-chain backbone as disclosed herein, together with lithium salt and optionally a free ionic liquid or other liquid organic electrolyte additive as disclosed herein.

In some embodiments, the intermediate solid polymeric electrolyte layer comprises a porous separator which is infiltrated with the conductive polymeric composition. The porous separator may be a microporous polymeric film. For example, the porous separator may comprise polyolefin (polyethylene, polypropylene and the like), fluorine resin (polytetrafluoroethylene and the like), polyaramid or polyimide. Alternatively, the porous separator may comprise paper or non-woven fabrics comprising resin fibre or glass fibre. The separator may comprise a single film or a laminate structure of multiple films, for example, polyethylene film/polypropylene film/polyethylene film. The porous separator may be impregnated with a conductive coating to facilitate the infiltration by the conductive polymeric composition and ionic conduction through the electrolyte layer. Examples of such impregnated separators, and methods for producing them, are disclosed in US2019/0270876A1 and JP7138267B2.

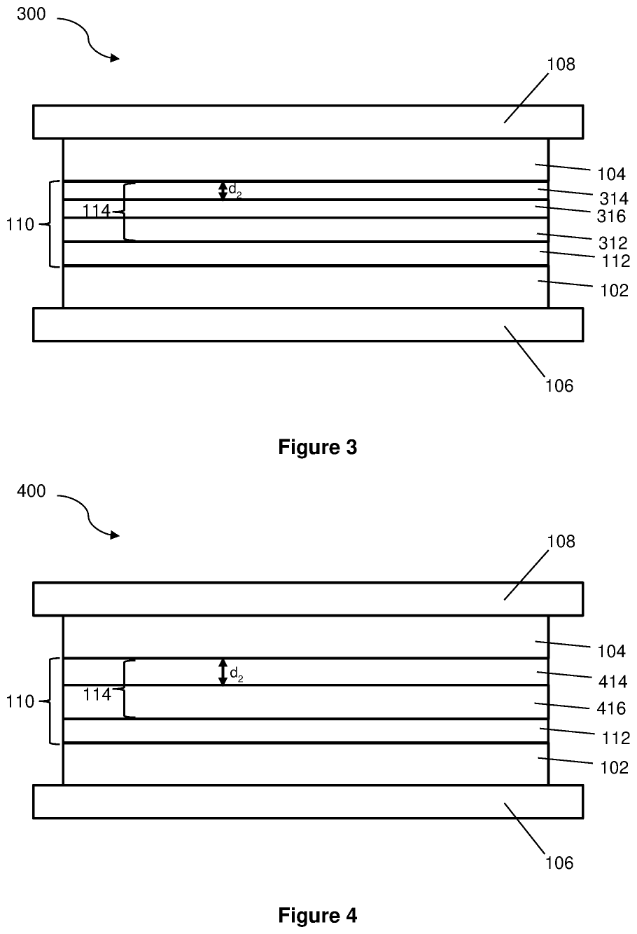

Schematically depicted in FIG. 3 is a rechargeable lithium metal cell 300 according to some embodiments. Numbered items of cell 300 are generally as described herein for cell 100 with reference to FIG. 1. Each lithium-conductive layer 110 of cell 300 is a solid-state electrolyte layer. Cell 300 comprises solid polymeric catholyte layer 314 as one of the further electrolyte layers 114 which space apart polymeric anolyte layer 112 from cathode 104. Catholyte layer 314 comprises (i) a fluorinated polymer comprising pendant ionic groups covalently coupled to the polymer backbone as disclosed herein, (ii) lithium salt, and optionally (iii) free ionic liquid. The composition of catholyte layer 314 may be infiltrated into the porosity of cathode 104, but catholyte layer 314 nevertheless forms a continuous overlying film on the surface of cathode 104, having a thickness (marked d₂) of between 1 and 10 μm, such as about 5 μm.

Cell 300 comprises, as another of the further electrolyte layers 114, intermediate electrolyte layer 316 interposed between solid polymeric catholyte layer 314 and solid polymeric anolyte layer 112. Intermediate electrolyte layer 316 comprises a porous separator which is infiltrated with a conductive polymeric composition which comprises (i) a fluorinated polymer comprising pendant ionic groups covalently coupled to the polymer backbone as disclosed herein, (ii) lithium salt, and optionally (iii) free ionic liquid.

Cell 300 optionally also comprises, as another of the further electrolyte layers 114, second polymeric anolyte layer 312 located adjacent to solid polymeric anolyte layer 112 but spaced apart from cathode 104 by layers 314 and 316. Second polymeric anolyte layer 312 may have the same composition as solid polymeric anolyte layer 112. As explained for cell 200, the presence of two similar or identical solid polymeric electrolyte layers, such as layers 112 and 312 layers, may facilitate the fabrication of the cell and reduce the risk to cell performance posed by pinholes or other defects present in solid polymeric anolyte layer 112.

While intermediate solid polymeric electrolyte layers comprising ionic fluorinated polymers have been successfully demonstrated herein, other lithium-conductive polymeric compositions are also envisaged. In some embodiments, for example, the intermediate solid polymeric electrolyte layer comprises a lithium-solubilising non-ionic polymer, for example a poly(alkylene oxide) such as polyethylene oxide, in combination with lithium salt and optionally a free ionic liquid. Non-limiting examples of such polymeric electrolyte compositions, and their ability to reduce interfacial resistance between layers in a lithium cell, are disclosed in EP3285324A1.

### Liquid Electrolyte Layer

In some embodiments the cell includes, as a further electrolyte layer which spaces apart the solid polymeric anolyte layer from the cathode, a porous separator infiltrated with a liquid electrolyte comprising lithium salt. Optionally, this liquid electrolyte layer is an intermediate electrolyte layer interposed between a solid polymeric catholyte layer, as disclosed herein, and the solid polymeric anolyte layer.

The porous separator may be according to any of the embodiments disclosed herein in the context of the further solid polymeric electrolyte layer. For example, the porous separator may be a microporous polymeric film which is impregnated with a conductive coating to facilitate the infiltration by the liquid electrolyte.

The liquid electrolyte comprises lithium salt, which is dissolved in the liquid carrier of the electrolyte. The lithium salt may be the same or different as the lithium salt in the solid polymeric anolyte layer. In some embodiments, it is the same salt. In some embodiments, the salt lithium is selected from lithium bis(trifluoromethanesulfonyl)imide (Li-TFSI), lithium bis(fluorosulfonyl)imide (Li-FSI), lithium fluorosulfonyl-trifluoromethanesulfonyl imide (Li-FTFSI), lithium tris(trifluoromethanesulfonyl)methide, lithium tetrakis(3,5-bis(trifluoromethyl)-2,4,6-trifluoro-phenyl)borate (Li[C₆F₃(CF₃)₂]₄), lithium triflate (LiOTf), lithium tetrafluoroborate (LiBF₄), lithium hexafluorophosphate (LiPF₆), LiCₙF₂ₙ₊₁SO₃⁻ where n is an integer from 1 to 10, LiCₙF₂ₙ₊₁CO₂⁻ where n is an integer from 1 to 10, and a combination thereof.

In some embodiments, the liquid electrolyte comprises a free ionic liquid. The free ionic liquid may be present as the main or only liquid component of the liquid carrier. Optionally, the free ionic liquid may be supplemented by a polar aprotic molecular liquid such as tetraglyme (C₁₀H₂₂O₅), vinylidene carbonate (VC), fluoroethylene carbonate (FEC) for enhanced stability of Li⁺ transferability, and/or other electrolyte additives known to those skilled in the art.

In some embodiments, the cation of the free ionic liquid is selected from an ammonium cation, a pyridinium cation, a pyrrolidinium cation, a phosphonium cation, and a combination thereof. In some embodiments, the anion of the free ionic liquid is a fluorinated anion. The anion may be selected from the first group of counter anions as previously disclosed herein. Nonlimiting examples of suitable free ionic liquids include 3-methyl-1-propylpyridinium bis(fluorosulfonyl)imide, 1-butyl-1-methylpyrolidinium bis(fluorosulfonyl)imide and the equivalent bis(trifluoromethanesulfonyl)imide salts.

While ionic liquid-based liquid electrolytes are preferred due to their good compatibility with lithium metal anodes and high voltage cathodes, it is not excluded that the liquid electrolyte comprises an organic solvent as the carrier for lithium salt. The liquid electrolyte may thus comprise a carbonate solvent. For example, the carbonate solvent may comprise one or more of dimethylcarbonate, diethylcarbonate, ethylmethylcarbonate, ethylene carbonate and propylene carbonate.

Schematically depicted in FIG. 4 is a rechargeable lithium metal cell 400 according to some embodiments. Numbered items of cell 400 are generally as described herein for cell 100 with reference to FIG. 1. Cell 400 comprises solid polymeric catholyte layer 414 as one of the further electrolyte layers 114 which space apart polymeric anolyte layer 112 from cathode 104. Catholyte layer 414 comprises (i) a fluorinated polymer comprising pendant ionic groups covalently coupled to the polymer backbone as disclosed herein, (ii) lithium salt, and optionally (iii) free ionic liquid. The composition of catholyte layer 414 may be infiltrated into the porosity of cathode 104, but catholyte layer 414 nevertheless forms a continuous overlying film on the surface of cathode 104, having a thickness (marked d₂) of between 1 and 10 μm, such as about 5 μm.

Cell 400 comprises, as another of the further electrolyte layers 114, intermediate liquid electrolyte-based layer 416 interposed between solid polymeric catholyte layer 414 and solid polymeric anolyte layer 112. Liquid electrolyte-based layer 416 comprises a porous separator which is infiltrated with a liquid electrolyte comprising free ionic liquid and lithium salt.

The liquid electrolyte-based layer may be produced in the cell structure by any method. In some embodiments, the porous separator is placed, in the absence of the liquid electrolyte, against the solid polymeric catholyte layer and subsequently infiltrated with the liquid electrolyte. For example, the porous separator may be sandwiched between the solid polymeric catholyte layer and the solid polymeric anolyte layer in a cell structure as seen in FIG. 4, and the liquid electrolyte composition is subsequently infiltrated under vacuum into the porosity of the separator.

### Solid Inorganic Electrolyte Layer

In some embodiments the cell includes, as a further electrolyte layer which spaces apart the solid polymeric anolyte layer from the cathode, a solid inorganic electrolyte layer comprising mobile lithium ions. Optionally, the solid inorganic electrolyte layer is an intermediate electrolyte layer interposed between a solid polymeric catholyte layer, as disclosed herein, and the solid polymeric anolyte layer. However, solid inorganic electrolyte layers may also be compatibilized with the cathode by other methods, including by placing it directly adjacent the cathode and applying a very high pressure compaction to reduce the resistance at the interface between the two solid layers. Thus, some embodiments of the invention do not include a solid polymeric catholyte layer as disclosed herein.

The solid inorganic electrolyte layer may comprise a lithium-containing inorganic material selected from a garnet, a NASICON-type material, a sulfide and a perovskite. Non-limiting examples of suitable garnets include LLZ materials such as Li_{6.25}La₃Zr₂Al_{0.25}O₁₂, Li_{6.6}La₃Zr_{1.6}Ta_{0.4}O₁₂, Li_{6.75}La₃Zr_{1.75}Nb_{0.25}O₁₂ (cubic phase) and Li₇La₃Zr₂O₁₂ (tetra), and LLT materials such as Li_{0.33}La_{0.55}TiO₃ (cubic phase), Li_{0.33}La_{0.55}TiO₃ (tetragonal phase), Li₅La₃Ta₂O₁₂ and Li₆La₃Ta_{1.5}Y_{0.5}O₁₂. Non-limiting examples of suitable NASICON-type materials include Li₍₁₊ₓ₎AlxTi₍₂₋ₓ₎(PO₄)₃ (where x=0.1 to 1.5, preferably 0.1 to 0.8), e.g. Li_{1.4}Al_{0.4}Ti_{1.6}(PO₄)₃, Li₍₁₊₄ₓ₎Zr₍₂₋ₓ₎(PO₄)₃ (x=0.1 to 1.5, preferably 0.1 to 0.8 and part of the Zr can be substituted by an element selected from the group consisting of Al, Ca, Ba, Sr, Sc, Y and In), LATP materials such as Li₃PO₄, Li₄SiPO₄, Li₄SiPO₄—Li₃PO₄, Li₃BO₄ and LAGP materials such as Li_{1.5}Al_{0.5}Ge_{1.5}P₃O₁₂. Non-limiting examples of suitable sulfides include Li₂S·P₂S₅, Li_{3.25}P_{0.95}S₄, Li_{3.2}P_{0.96}S₄, Li₄P₂S₆ and Li₂P₃S₁₁ and Argyrodite Li₆PS₅Cl—Br. A suitable perovskite is LaₓLi_{y}TiO_{z}. Particularly preferred materials are lithium lanthanum zirconate garnet, i.e. LLZO-Nb (garnet), lithium aluminum titanium phosphate, i.e. LATP (NASICON) and Argyrodite Li₆PS₅Cl—Br (sulfide).

The solid inorganic electrolyte layer may further comprise one or more of the following components: (i) a fluorinated ionic polymer, such as a fluorinated polymer comprising pendant ionic groups covalently coupled to the polymer backbone as disclosed herein, (ii) a non-ionic polymer, such as a polyalkylene glycol derivative, (iii) an ionic additive selected from a free ionic liquid, a monomer comprising an ionic liquid cation and a polymer thereof, and (iv) lithium salt. Non-limiting examples of inorganic electrolyte compositions suitable for the solid inorganic electrolyte layer are disclosed in US2020/0350616.

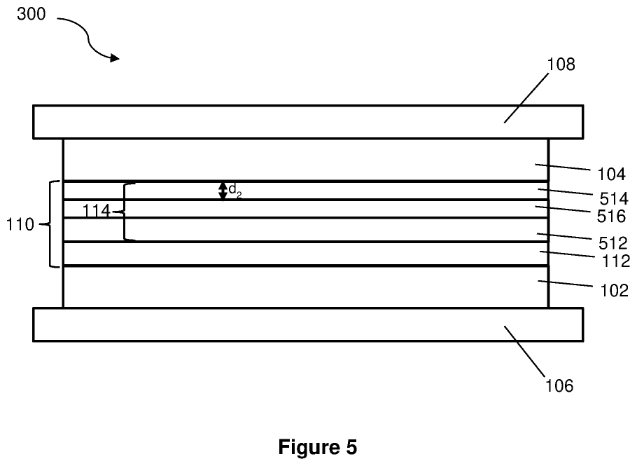

Schematically depicted in FIG. 5 is a rechargeable lithium metal cell 500 according to some embodiments. Numbered items of cell 500 are generally as described herein for cell 100 with reference to FIG. 1. Each lithium-conductive layer 110 of cell 500 is a solid-state electrolyte layer. Cell 500 comprises solid polymeric catholyte layer 514 as one of the further electrolyte layers 114 which space apart polymeric anolyte layer 112 from cathode 104. Catholyte layer 514 comprises (i) a fluorinated polymer comprising pendant ionic groups covalently coupled to the polymer backbone as disclosed herein, (ii) lithium salt, and optionally (iii) free ionic liquid. The composition of catholyte layer 514 may be infiltrated into the porosity of cathode 104, but catholyte layer 514 nevertheless forms a continuous overlying film on the surface of cathode 104, having a thickness (marked d₂) of between 1 and 10 μm, such as about 5 μm.

Cell 500 comprises, as another of the further electrolyte layers 114, intermediate solid inorganic electrolyte layer 516 interposed between solid polymeric catholyte layer 514 and solid polymeric anolyte layer 112. Solid inorganic electrolyte layer 516 comprises a lithium-containing inorganic material together with one or more of a fluorinated ionic polymer, non-ionic polymer, ionic additive and lithium salt.

Cell 500 optionally also comprises, as another of the further electrolyte layers 114, second polymeric anolyte layer 512 located adjacent to solid polymeric anolyte layer 112 but spaced apart from cathode 104 by layers 514 and 516. Second polymeric anolyte layer 512, having a similar purpose as layers 212 and 312 as described with reference to FIGS. 2 and 3, may have the same composition as solid polymeric anolyte layer 112.

### Method of Cycling the Rechargeable Lithium Metal Cell

The invention further relates to a method of cycling a rechargeable lithium metal cell as disclosed herein. The method comprises one or more cycles of (i) charging the rechargeable lithium metal cell to a charge cut-off voltage of at least 4.1 V, and (ii) discharging the rechargeable lithium metal cell. In some embodiments, the rechargeable lithium metal cell is charged to a charge cut-off voltage of at least 4.25 V, such as at least 4.35 V, for example at least 4.5 V, during the charging.

In some embodiments, the rechargeable lithium metal cell retains at least 90% of capacity after 100 charge-discharge cycles conducted at 0.2 C and 50° C. with a charge cut-off voltage of at least 4.25 V. In some embodiments, this capacity retention is obtained with a charge cut-off voltage of at least 4.35 V, or at least 4.5 V.

In some embodiments, the rechargeable lithium metal cell retains at least 85% of capacity after 100 charge-discharge cycles conducted at 0.2 C and 25° C. with a charge cut-off voltage of at least 4.25 V. In some embodiments, this capacity retention is obtained with a charge cut-off voltage of at least 4.35 V, or at least 4.5 V.

### Method of Producing a Rechargeable Lithium Metal Cell

The invention further relates to a method of producing a rechargeable lithium metal cell as disclosed herein. The method comprises providing an anode half-cell comprising the anode and a cathode half-cell comprising the cathode, and assembling the anode half-cell and cathode half-cell to provide the rechargeable lithium metal cell with the plurality of lithium-conductive layers interposed between the anode and the cathode.

In some embodiments, the anode half-cell comprises the solid polymeric anolyte layer adhered to the anode before assembling the anode half-cell and the cathode half-cell. The method may thus comprise a step of producing the solid polymeric anolyte layer as a coating on the anode. In some embodiments, the coating is applied by a coating technique selected from slot-die coating, comma coating or melt extrusion, which techniques are particularly suitable for producing thin film coatings as preferred. The applied coating may subsequently be dried and/or hot pressed at elevated temperature and reduced pressure to produce the final structure of the solid polymeric anolyte layer, adhered to the anode.

In some embodiments, the cathode half-cell comprises, as an outer layer, a second polymeric anolyte layer comprising the block copolymer and lithium salt. Assembling the anode half-cell and the cathode half-cell then comprises bonding the solid polymeric anolyte layer to the second polymeric anolyte layer, for example under pressure at elevated temperatures.

In some embodiments, the cathode half-cell comprises a solid catholyte layer adjacent the cathode, as disclosed herein. The solid catholyte layer may be a solid polymeric catholyte layer comprising lithium salt. Providing the cathode half-cell may comprise applying a catholyte composition as a precursor fluid to the cathode substrate, with sufficient catholyte composition applied to infiltrate the porous cathode and to form a continuous overlying film on the surface of the cathode. The application may be by any suitable coating methodology, optionally including a roller pressing and drying steps.

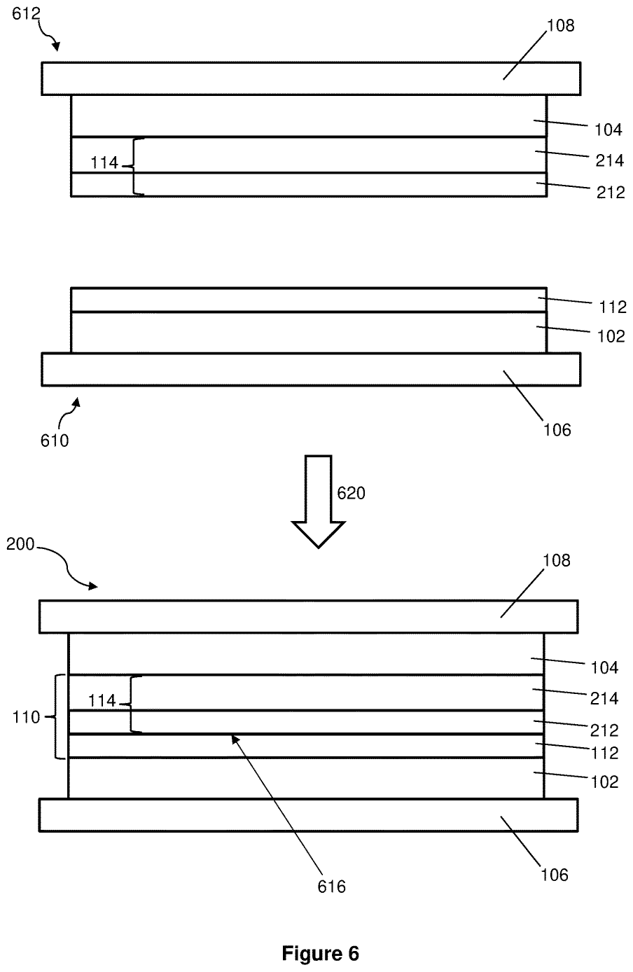

A method of producing rechargeable lithium metal cell 200, as disclosed herein with reference to FIG. 2, will now be described with reference to FIG. 6. Numbered items in FIG. 6 are thus generally as described herein for cell 200.

The method comprises providing anode half-cell 610 comprising lithium metal anode 102, present on anodic current collector 106, and solid polymeric anolyte layer 112 adhered to the anode. For example, solid polymeric anolyte layer 112 may be produced as a coating on the metallic lithium surface of the anode to produce a layer of between 0.5 and 20 μm thick.

The method further comprises providing cathode half-cell 612 comprising high-voltage cathode 104, present on cathodic current collector 108. Cathode half-cell 612 further comprises one or more further electrolyte layers 214 and, as an outer layer, second polymeric anolyte layer 212. Electrolyte layers 214 may suitably include one or more solid state electrolyte layers such as a solid polymeric catholyte layer and/or a solid inorganic electrolyte layer, as disclosed herein. Second polymeric anolyte layer 212 comprises a block copolymer, lithium salt and optionally free ionic liquid, and may optionally have substantially the same composition as solid polymeric anolyte layer 112. Second polymeric anolyte layer 212 may be produced on the electrolyte layer 214 by a similar manner as solid polymeric anolyte layer 112.

The method comprises a step (represented by arrow 620) of assembling anode half-cell 610 and cathode half-cell 612 so as to provide rechargeable lithium metal cell 200 with the plurality of lithium-conductive layers 110 (including layer 112, layer 212 and one or more layers 214) interposed between anode 102 and cathode 104. This is done by stacking the two half-cells and bonding solid polymeric anolyte layer 112 to second polymeric anolyte layer 212. Advantageously, the resultant cell is mechanically robust and has excellent lithium transport properties across the newly formed interface 616 between the two half-cell components because of the bonding between the two similar, or identical, solid polymeric electrolyte layers.

### Cathode Half-Cell

The invention further relates to a cathode half-cell which is suitable for producing a rechargeable lithium metal cell according to some embodiments disclosed herein. The cathode half-cell comprises a cathode comprising a high-voltage cathode material, the cathode supported on a current collector; a solid polymeric anolyte layer; and one or more further electrolyte layers which space apart the solid polymeric anolyte layer from the cathode. The solid polymeric anolyte layer comprises (i) a block copolymer comprising at least one hydrophobic non-ionic block and at least one ionic block and (ii) lithium salt. The solid polymeric anolyte layer has at least two glass transition temperature (Tg) values.

The cathode half-cell is envisaged for use in a method of producing a rechargeable lithium metal cell, as disclosed herein, and is described further in the section describing that method.

### EXAMPLES

The present invention is described with reference to the following examples. It is to be understood that the examples are illustrative of and not limiting to the invention described herein.

### Materials

A battery-grade metallic lithium foil of thickness 10 μm or 20 μm, laminated onto a copper foil of thickness 10 μm, was used for the cell anodes.

Two grafted PVDF polymers (Pioxcel CB grafted PVDF and Treklite CP grafted PVDF) having the structure below were obtained from Piotrek Co, Ltd (Japan).

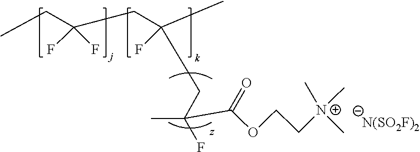

Pioxcel CB grafted PVDF had a molecular weight of about 700,000 Da, and an ionic content of 5-50 mol %. Treklite CP had a molecular weight of about 700,000 Da, and an ionic content of 40-85 mol %.

A polymerized ionic liquid homopolymer, poly(2-[methacryloyloxy]ethyl trimethylammonium bis(fluorosulfonyl)imide), (Treklite p-MA23F) was obtained from Piotrek Co, Ltd (Japan). A polyalkyleneoxide modified siloxane composition (Trekwet S64L) was obtained from Piotrek Co, Ltd (Japan).

A polyalkylene triol polyacrylate (GEP-2800AA) as described in Japanese patent JP4904553B2, having the structure shown below, was obtained from Piotrek Co, Ltd (Japan).

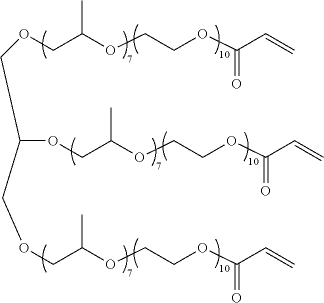

The ionic liquid 3-methyl-1-propylpyridinium bis(fluorosulfonyl)imide (MPPY-FSI) was obtained from Piotrek Co, Ltd (Japan). Lithium bis(fluorosulfonyl)imide (LiNO₄F₂S₂; LiFSI) was obtained from a commercial supplier. Nano-size carbon, Super C65 ex MTI USA was purchased for use as the conductive carbon for cathode synthesis. The high-nickel content cathode materials Ni_{0.6}Co_{0.2}Mn_{0.2}O₂ (NMC622) and Ni_{0.8}Co_{0.1}Mn_{0.1}O₂ (NMC811) were obtained from commercial supplier Hi-Chem. LLZO-Nb garnet material, of formula Li_{6.5}La₃Zr_{1.5}Nb_{0.5}O₁₂, was obtained from Toshima Mnfg (Japan). LATP NASICON material, of formula Li_{1.3}Al_{0.3}Ti_{1.7}P₃O₁₂, was obtained from Toshima Mnfg (Japan). An argyrodite LPS-halide (Cl) sulfide material, of formula Li₆PS₅Cl_{0.5}Br_{0.5}, (LiPSCl) was obtained from Toshima Mnfg (Japan).

A porous polypropylene separator processed with Treklite CP grafted PVDF (“CP-PP separator”) was obtained from Piotrek Co, Ltd (Japan). The processing creates three-dimensionally structured layers of the separator (2-6 μm on each side of the 15 μm polypropylene separator) which is modified by the ionic polymer.

### Example 1. Synthesis of Block Copolymers Comprising a Polymerized Ionic Liquid Block

A high molecular weight triblock polymer, PS-b-PIL-b-PS, was prepared by the following procedure.

### Synthesis of RAFT Agent: Dimethyl 2,6-di((dodecylthio)thiocarbonylthio)-heptanedioate

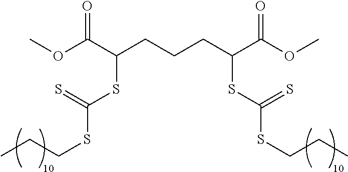

Prepared using similar procedure as that described in A. M. Bivigou-Koumba, J. Kristen, A. Laschewsky, P. Müller-Buschbaum, C. M. Papadakis. Macromol. Chem. Phys. 2009, 210, 565-578.

1-Dodecanethiol (16.60 g, 0.082 mol) and triethylamine (8.78 g, 0.087 mol) were added to dichloromethane (100 mL) under nitrogen and cooled in an ice bath. To this solution was then added carbon disulfide (6.62 g, 0.087 mol) dropwise with stirring, the ice bath removed, and the solution bought to ambient temperature with stirring continued for another 2 hours. A solution of Dimethyl 2,6-dibromoheptanedioate (15.0 g, 0.043 mol) in dichloromethane (45 mL) was added and stirring continued at ambient temperature under nitrogen for another 3 hrs. The solvent was removed in a rotary evaporator and to the residue was added diethyl ether (~150 mL) and the resulting mixture filtered through a large plug of silica gel. The solvent was removed again using a rotary evaporator giving the crude product as a yellow viscous oil, which was purified by column chromatography (9:1 hexanes/ethyl acetate on silica gel). ¹H NMR (CDCl₃) δ 4.83 (t, (CO)CHS, 2H), 3.73 (s, OCH₃, 6H), 3.35 (t, SCH₂, 4H), 2.07-1.87 (m, (CO)CHCH₂, 4H), 1.69 (pentet, SCH₂CH₂, 4H), 1.56 (m, (CO)CHCH₂CH₂, 2H), 1.39 (br m, SCH₂CH₂CH₂, 4H), 1.35-1.20 (br, CH₂-dodecyl, 32H), 0.88 (t, CH₃-dodecyl, 6H) ppm.

### Synthesis of Bis-α,ω-(dodecylthio)thiocarbonylthio-functionalised poly(2-bromoethyl acrylate), (pBrEA)

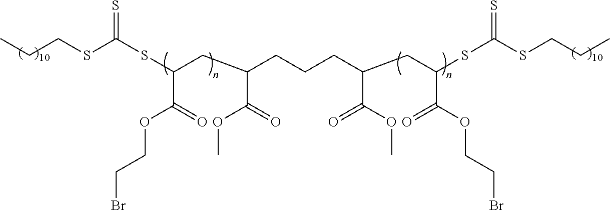

A solution of 2-Bromoethylacrylate (1500 g, 8.38 mol) and Dimethyl 2,6-di((dodecylthio)thiocarbonylthio) heptanedioate RAFT agent (19.11 g, 0.0258 mmol) in ethyl acetate (3 L) was added to a 10 L volume transparent glass oil-jacketed reactor that was pre-purged with argon. Argon was then bubbled through the solution via a PTFE tube for ~30 mins, then heated to reflux temperature. The stirred reaction solution was irradiated with blue light (4× Kessil 427 nm LED light sources operating at 50% power setting, evenly spaced around reactor, spaced 10 cm from outer walls of reactor). The reaction was stopped once 40% monomer conversion was reached (analysis by ¹H NMR in CDCl₃). The solution was cooled and then added in a steady stream to petroleum ether with stirring to precipitate the product polymer. The supernatant was decanted and the polymer residue re-precipitated from ethyl acetate solution into hexanes and dried under vacuum at ambient temperature overnight, giving a sticky yellow tar-like product. Mₙ (calculated, based on monomer conversion): 23750 (DP=130). GPC (Dimethylacetamide/LiBr, PS std.): Mₙ 20900, M_{w} 23200, M_{w}/Mₙ 1.11, Mₚ 22600.

### Synthesis of Bis-α,ω-(dodecylthio)thiocarbonylthio-functionalised polystyrene-b-poly(2-bromoethyl acrylate)-b-polystyrene, (PS-b-pBrEA-b-PS)

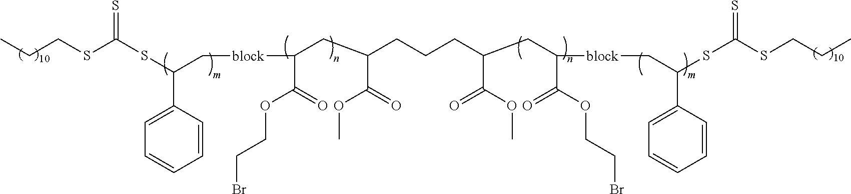

The polymer product from the previous step, bis-α,ω-(dodecylthio)thiocarbonylthio-functionalised poly(2-bromoethyl acrylate) (594 g, 0.025 mol) was dissolved in a mixture of styrene (3347 g, 32.1 mol) and toluene (1 L) and added to a 10 L volume oil-jacketed reactor that was pre-purged with argon. Argon was then bubbled through the solution via a PTFE tube for ~30 mins, then heated to an internal temperature of 117° C. The reaction was stopped once 42% monomer conversion was reached (~12 hrs, analysis by ¹H NMR in CDCl₃). The reaction solution was diluted with ethyl acetate to about double the volume and then poured as a steady stream into methanol with vigorous mechanical stirring. Stirring was continued overnight and the precipitated polymer collected by filtration, sucked dry for several hours on the filter funnel and dried further in an oven at 45° C. under vacuum, giving a yellow coloured powder (~1.9 kg). GPC (Dimethylacetamide/LiBr, PS std.): Mₙ 62500, M_{w} 77450, M_{w}/Mₙ 1.24, Mₚ 75050. ¹H NMR analysis gave PS: pBrEA molar ratio of 3.22:1, equating to 34.8% pBrEA weight fraction.

### Synthesis of Bis-α,ω-(dodecylthio)thiocarbonylthio-functionalised polystyrene-b-poly(2-(butylimidazolium(TFSI))ethyl acrylate)-b-polystyrene, (PS-b-PIL-b-PS)

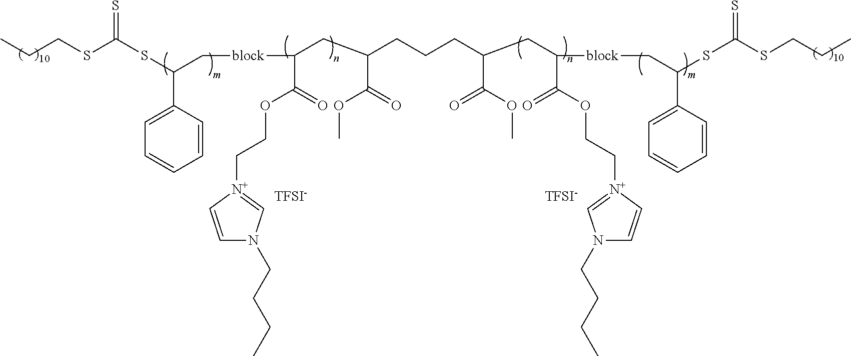

Bis-α,ω-(dodecylthio)thiocarbonylthio-functionalised polystyrene-block-poly(2-bromoethyl acrylate)-block-polystyrene (1.57 kg, 34.8 wt % pBrEA fraction: 546.4 g pBrEA fraction, 3.052 mol BrEA monomer units) was dissolved in anhydrous DMF (5 L) under a dry nitrogen atmosphere with heating to 40° C. To the solution was added anhydrous 1-Butylimidazole (1.24 kg, 9.98 mol). The temperature was raised to 80° C. and reaction mixture gently stirred for 24 hrs for complete quaternisation, forming the butylimidazolium bromide functionalised triblock copolymer. The reaction solution was cooled to 50° C. and then a solution of lithium bis(trifluoromethanesulfonyl)imide (1.42 kg, 4.95 mol) in DMF (2.5 L) added, stirred for 2 hrs, then cooled to ambient temperature. Methyl ethyl ketone (3.6 L) was added to further dilute the mixture which was then poured as a steady stream over 10 minutes to a large excess of methanol/water (1:1, 90 L) with vigorous mechanical stirring to precipitate the product polymer. Stirring of the mixture was continued overnight and the solid then collected by filtration and washed with deionised water (30 L). The solid was re-suspended in deionised water (85 L) and stirred vigorously for 24 hours, filtered, rinsed with further portions of water then dried on the filter under vacuum. The solid was transferred to a oven set at 50° C. and dried until constant weight achieved. Yield: 2.31 kg. ¹H NMR (CDCl₃/DMSO-d₆/AcOD) δ 8.89 (br s, imidazolium NCHN), 7.60-7.40 (br m, imidazolium NCHCHN), 7.20-6.15 (polystyrene ArH), 4.60-3.90 (br m, OCH₂CH₂N, butyl-CH₂N), 2.46-1.0 (backbone CHCH₂, butyl-CH₂CH₂), 0.84 (t, butyl-CH₃) ppm. PS:PIL molar ratio 4.78:1, calculated PS weight fraction 49.7%.

The molecular weight of PS-b-PIL-b-PS was about 125,000 Da (31,350 Da for each PS block; 63,000 for the PIL block).

A lower molecular weight diblock polymer, PS-b-PIL having the structure shown below, was prepared by procedures as previously reported in WO2019/084623.

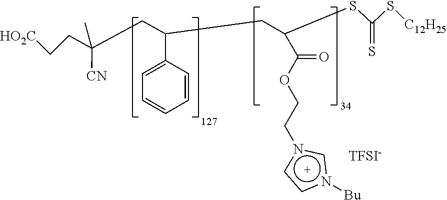

The molecular weight of PS-b-PIL was about 30,000 Da (about 13,200 Da for the PS block) and the ionic ratio about 22 mol %.

The block copolymers produced in this Example are occasionally referred to hereafter as “Pilblox” (Polymerized ionic liquid block copolymer).

### Example 2. Fabrication and Testing of Lithium Metal Cell Comprising Multiple Solid Polymeric Electrolyte Layers

A Li metal/NMC622 cell having the configuration of cell 300 described herein with reference to FIG. 3 (with component layers numbered accordingly) was prepared and evaluated.

### Fabrication

Step 1. A coating slurry for anolyte preparation was prepared by dissolving the high molecular weight triblock copolymer PS-b-PIL-b-PS (as prepared in Example 1) (9 wt. %) in tetrahydrofuran (THF) (81.7 wt. %), followed by addition of MPPY-FSI ionic liquid (4.2 wt. %) and LiFSI lithium salt (5.1 wt. %). The coating slurry was coated on lithium metal foil (20 μm thickness, laminated on copper foil), and dried in an oven at 50° C. for 24 hours under vacuum (−0.1 MPa) to remove solvent and produce a continuous Pilblox-based anolyte layer (112) having a thickness of about 10 μm on the lithium anode (102) supported on a copper foil current collector (106). DSC analysis of the Pilblox-based anolyte composition indicated two Tg's at −59.5° C. attributed to the ionic phase and at about 100° C. for the polystyrene phase This completed the preparation of the anode half-cell used to fabricate the cell.

Step 2. Conductive carbon (CC) and Pioxcel CB grafted PVDF were combined in a weight ratio of 1:0.6 and stirred to make a uniform powder mixture. MPPY-FSI ionic liquid was added in an amount of 0.4 to produce a conductive adhesive having a weight ratio of 1:1 of CC to ionic additives (grafted PVDF+ionic liquid). This conductive adhesive (5 wt. %) was then combined with NCM622 (95 wt. %) in N-methyl-2-pyrrolidone (NMP) to make a cathode casting slurry having c.a. 68 wt. % of non-volatile content. This cathode casting slurry was coated on aluminium foil and dried at 80° C. for 1 hour under vacuum to produce a porous NMC622-based cathode (104) having a capacity of 2.2 mAh/cm², supported on an aluminium foil current collector (108).

Step 3. A first polymeric electrolyte coating slurry was prepared by dissolving Treklite CP grafted PVDF (6 wt. %) in acetonitrile (70 wt. %), followed by addition of MPPY-FSI ionic liquid (18 wt. %) and LiFSI lithium salt (6 wt. %). This polymeric electrolyte coating slurry was then roller pressed on the porous NMC622-based cathode so that the slurry infused into the porosity of the cathode while leaving a layer of liquid slurry on the surface sufficient to produce a polymeric catholyte layer (314) having a thickness of about 5 μm after drying at 80° C. for 24 hours under vacuum (−0.1 MPa).

Step 4. A second polymeric electrolyte coating slurry was prepared by dissolving Treklite CP grafted PVDF (20 wt. %) in acetonitrile (56 wt. %), followed by addition of MPPY-FSI ionic liquid (18 wt. %) and LiFSI lithium salt (6 wt. %). This polymeric electrolyte coating slurry was coated on the polymeric catholyte layer (314) to produce a liquid layer of about 5 μm thickness. A CP-PP separator (c.a. 15 μm thickness) was then dipped into the liquid layer, allowing the liquid to impregnate into the separator porosity, and dried at 80° C. for 24 hours under vacuum (−0.1 MPa) to produce a further solid polymeric electrolyte layer (316), comprising a porous separator infiltrated with a conductive polymeric composition, on the polymeric catholyte layer (314).

Step 5. A coating slurry as prepared in step 1 was then coated on the further solid polymeric electrolyte layer (316) and dried in an oven at 50° C. for 24 hours under vacuum (−0.1 MPa) to produce a second continuous Pilblox-based anolyte layer (312) having a thickness of about 10 μm. This completed the preparation of the cathode half-cell used to fabricate the cell.

Step 6. The lithium metal cell (300) was then produced by stacking the anode half-cell (produced in step 1) and the cathode half-cell (produced in step 5) with the first and second Pilblox-based anolyte layers (112, 312) in contact. The cell was subjected to heat pressing at 100 kg/cm² of pressure at 80° C. for 10 minutes under vacuum (0.1 MPa) to bond the Pilblox-layers and to establish an ionically conductive network throughout the lithium-conductive layers between the cathode and anode.

### Cell Testing.

The cell, having a size of 5 cm×5 cm and a theoretical capacity of about 50 mAh (=5 cm×5 cm×2.2 mAh/cm²), was retained in a fitting holder and evaluated at high voltage (4.3 V) using a TOSCAT3600 charge-discharge test system (Toyo system Co, Ltd) according to the test procedure set out in the table below. The initial chemical conversion processing treatment (CCP-1) involved charging/discharging for 10 hours at 50° C. to help form a uniform conductive network inside of the cell structure.

| | | | | | | |
|---|---|---|---|---|---|---|
| Program | Rating | Voltage | Current (mA) | Cut term | Cycle no. | Temp |

Chemical Conversion Processing treatment

| | | | | | | | | | |
|---|---|---|---|---|---|---|---|---|---|
| CCP-1 | Charging | 0.1 | C | 4.5 V | 5.5 | 2.75 | mA | 2 | 50° C. |
| | Discharging | 0.2 | C | — | 11.0 | 2.5 | V | | |

Rating and cycling

| | | | | | | | | | |
|---|---|---|---|---|---|---|---|---|---|
| Cycle-1st | Charging | 0.20 | C | 4.3 V | 11.0 | 2.75 | mA | 2 | 50° C. |
| | Discharging | 0.2 | C | — | 11.0 | 2.5 | V | | |
| Cycle-2nd | Charging | 0.50 | C | 4.3 V | 27.5 | 2.75 | mA | 1 | 50° C. |
| | Discharging | 0.5 | C | — | 27.5 | 2.5 | V | | |
| Cycle-3rd | Charging | 1.0 | C | 4.3 V | 55.0 | 2.75 | mA | 1 | 50° C. |
| | Discharging | 1.0 | C | — | 55.0 | 2.5 | V | | |
| Cycle-4th | Charging | 2.0 | C | 4.3 V | 110.0 | 2.75 | mA | 1 | 50° C. |
| | Discharging | 2.0 | C | — | 110.0 | 2.5 | V | | |
| Cycle-5th | Charging | 0.2 | C | 4.3 V | 11.0 | 2.75 | mA | 1 | 50° C. |
| | Discharging | 0.2 | C | — | 11.0 | 2.5 | V | | |
| Cycled | Charging | 0.1 | C | 4.3 V | 5.5 | 2.75 | mA | 100 | 50° C. |
| | Discharging | 0.1 | C | — | 5.5 | 2.5 | V | | |

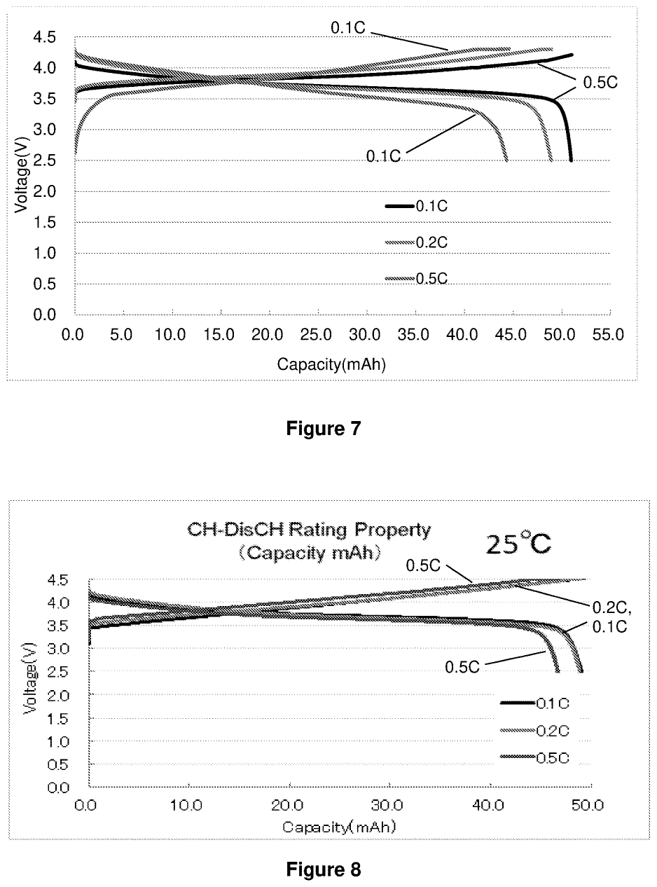

Cycling results at 0.1 C, 0.2 C and 0.5 C are shown in FIG. 7. At 0.2 C rating, the measured capacity was 49.76 mAh, providing a Coulombic efficiency rate of 99.8%. The effect of 100 cycles at 0.1 C, 50° C. was to gradually reduce the measured capacity from 50.18 mAh to 47.48 mAh, thus providing a capacity retention of 94.6%).

### Example 3. Fabrication and Testing of an Lithium Metal Cell Comprising an Ionic Liquid Electrolyte Layer

A Li metal/NMC811 cell having the configuration of cell 400 described herein with reference to FIG. 4 (with component layers numbered accordingly) was prepared and evaluated.

### Fabrication

Step 1. An anode half-cell, comprising a Pilblox-based anolyte layer (112) on a lithium anode (102) supported on a copper foil current collector (106), was prepared by the same procedure as step 1 in Example 2.

Step 2. A porous NMC811-based cathode (104), having a capacity of 2.2 mAh/cm² and supported on an aluminium foil current collector (108), was prepared by the same procedure as step 2 in Example 2 except that NMC811 was used instead of NMC622.

Step 3. A polymeric catholyte layer (414) was produced on the porous NMC811-based cathode (104) by the same procedure as step 3 in Example 2, thus producing a cathode half-cell.

Step 4. A lithium metal cell (400) was then produced by interposing a CP-PP porous polymeric separator between the anode half-cell (produced in step 1) and the cathode half-cell (produced in step 3), placing the laminate structure into a flat cell bag, and infusing a liquid electrolyte into the cell under vacuum (−0.1 MPa) so that it infiltrated the separator forming a liquid electrolyte layer (416). The liquid electrolyte contained vinylidene carbonate (VC) (4.6 wt. %), lithium bis(oxalate)borate (LiBOB) (0.9 wt. %), LIFSI lithium salt (1.2 M) and Trekwet S64L (1.9 wt. %) dissolved in an MPPY-FSI ionic liquid. The liquid electrolyte was made by adding 5 parts VC, 1 part LiBOB, and 2 parts Trekwet S64L to 100 parts of MPPY-FSI+LiFSI1.2M, to give 108 parts total. The cell was then heated at 50° C. for 10 minutes, and the flat cell bag seal was opened to overflow excess liquid electrolyte and then vacuum sealed again.

### Cell Testing.

The cell, having a size of 5 cm×5 cm and a theoretical capacity of about 50 mAh (=5 cm×5 cm×2.2 mAh/cm²), was evaluated at high voltage (4.5 V) using a TOSCAT3600 charge-discharge test system (Toyo system Co, Ltd) according to the test procedure set out in the table below. The initial chemical conversion processing treatment (CCP-1) involved charging/discharging for 10 hours at 50° C. to help form a uniform conductive network inside of the cell structure.

| | | | | | | |
|---|---|---|---|---|---|---|
| Program | Rating | Voltage | Current (mA) | Cut term | Cycle no. | Temp |

Chemical Conversion Processing treatment

| | | | | | | | | | |
|---|---|---|---|---|---|---|---|---|---|
| CCP-1 | Charging | 0.1 | C | 4.5 V | 5.5 | 2.75 | mA | 2 | 50° C. |
| | Discharging | 0.2 | C | — | 11.0 | 2.5 | V | | |

Rating and cycling

| | | | | | | | | | |
|---|---|---|---|---|---|---|---|---|---|
| Cycle-1st | Charging | 0.20 | C | 4.5 V | 10.0 | 2.5 | mA | 2 | 25° C. |
| | Discharging | 0.2 | C | — | 10.0 | 2.5 | V | | |
| Cycle-2nd | Charging | 0.50 | C | 4.5 V | 25.0 | 2.5 | mA | 1 | 25° C. |
| | Discharging | 0.5 | C | — | 25.0 | 2.5 | V | | |
| Cycle-3rd | Charging | 1.0 | C | 4.5 V | 50.0 | 2.5 | mA | 1 | 25° C. |
| | Discharging | 1.0 | C | — | 50.0 | 2.5 | V | | |
| Cycle-4th | Charging | 2.0 | C | 4.5 V | 100.0 | 2.5 | mA | 1 | 25° C. |
| | Discharging | 2.0 | C | — | 100.0 | 2.5 | V | | |
| Cycle-5th | Charging | 0.2 | C | 4.5 V | 10.0 | 2.5 | mA | 1 | 25° C. |
| | Discharging | 0.2 | C | — | 10.0 | 2.5 | V | | |
| Cycled | Charging | 0.5 | C | 4.5 V | 25.0 | 2.5 | mA | 100 | 25° C. |
| | Discharging | 0.5 | C | — | 25.0 | 2.5 | V | | |

Cycling results at 0.1 C, 0.2 C and 0.5 C are shown in FIG. 8. At 0.2 C rating, the measured capacity was 49.25 mAh, providing a Coulombic efficiency rate of 99.2%. The effect of 100 cycles at 0.50, 25° C. was to gradually reduce the measured capacity from 46.7 mAh to 43.5 mAh, thus providing a capacity retention of 93.1%.

Another Li metal/NMC811 cell having the configuration of cell 400 was prepared and evaluated. Differently from that just described, this cell included a porous NMC811-based cathode (104) having a capacity of 4.0 mAh/cm² and the liquid electrolyte present in liquid electrolyte layer (416) was 1.0 M LiPF₆ in 1:1 ethylene carbonate/diethyl carbonate solvent.

The cell was cycled at 0.5 C and 25° C., giving a measured capacity of 104 mAh and a Coulombic efficiency of 99.8%. The effect of 200 cycles at 0.50, 25° C. was to gradually reduce the measured capacity from 103.2 mAh to 97.56 mAh, thus providing a capacity retention of 94.6%.

### Example 4. Fabrication and Testing of a Lithium Metal Cell Comprising a Solid-State Garnet-Based Electrolyte Layer

A Li metal/NMC811 cell having the configuration of cell 500 described herein with reference to FIG. 5 (with component layers numbered accordingly) was prepared and evaluated.

### Fabrication

Step 1. An anode half-cell, comprising a Pilblox-based anolyte layer (112) on a lithium anode (102) supported on a copper foil current collector (106), was prepared by the same procedure as step 1 in Example 2.

Step 2. A porous NMC811-based cathode (104), having a capacity of 2.2 mAh/cm² and supported on an aluminium foil current collector (108), was prepared by the same procedure as step 2 in Example 3.

Step 3. A polymeric catholyte layer (514) was produced on the porous NMC811-based cathode (104) by the same procedure as step 3 in Example 3, thus producing a cathode half-cell.

Step 4. An electrolyte solution was prepared by dissolving Treklite p-MA23F conductive additive (15 wt. %) in acetone (60 wt. %), followed by addition of MPPY-FSI ionic liquid (25 wt. %). A garnet-based coating slurry was then prepared by combining the electrolyte solution (13 wt. %), LLZO-Nb (48 wt. %) and LiFSI lithium salt (14 wt. %) with acetone (25 wt. %). The mixture was then blended with a planetary centrifugal mixer (2×5 min), further diluted with acetone to an optimum viscosity (achieved at 67% non-volatile content) and passed through a filtration sieve. The garnet-based electrolyte coating slurry was coated on the polymeric catholyte layer (514) and dried at 40° C. for 1 hour to provide a solid inorganic (garnet-based) electrolyte layer (516) on the polymeric catholyte layer (514) with a thickness of about 30 μm.

Step 5. A coating slurry as prepared in step 1 was then coated on the solid inorganic electrolyte layer (516) and dried in an oven at 50° C. for 24 hours under vacuum (−0.1 MPa) to produce a second Pilblox-based anolyte layer (512) having a thickness of about 5 μm. This completed the preparation of the cathode half-cell used to fabricate the cell.

Step 6. The lithium metal cell (500) was then produced by assembling the anode half-cell (produced in step 1) and the cathode half-cell (produced in step 5) with the first and second Pilblox-based anolyte layers (112, 512) in contact. The cell was subjected to heat pressing at 100 kg/cm² of pressure at 80° C. for 10 minutes under vacuum (0.1 MPa) to bond the Pilblox-layers and to establish an ionically conductive network throughout the lithium-conductive layers between the cathode and anode.

### Cell Testing.

The cell, having a size of 5 cm×5 cm and a theoretical capacity of about 50 mAh (=5 cm×5 cm×2.2 mAh/cm²), was evaluated at high voltage (4.3 V) using a TOSCAT3600 charge-discharge test system (Toyo system Co, Ltd) according to the test procedure set out in the table below. The initial chemical conversion processing treatment (CCP-1) involved charging/discharging for 10 hours at 50° C. to help form a uniform conductive network inside of the cell structure.

| | | | | | | |
|---|---|---|---|---|---|---|
| Program | Rating | Voltage | Current (mA) | Cut term | Cycle no. | Temp |

Chemical Conversion Processing treatment

| | | | | | | | | | |
|---|---|---|---|---|---|---|---|---|---|
| CCP-1 | Charging | 0.1 | C | 4.3 V | 1.2 | 0.6 | mA | 2 | 50° C. |
| | Discharging | 0.2 | C | — | 1.2 | 2.5 | V | | |

Rating and cycling

| | | | | | | | | | |
|---|---|---|---|---|---|---|---|---|---|
| Cycle-1st | Charging | 0.20 | C | 4.3 V | 2.4 | 0.6 | mA | 2 | 50° C. |
| | Discharging | 0.2 | C | — | 2.4 | 2.5 | V | | |
| Cycle-2nd | Charging | 0.50 | C | 4.3 V | 6 | 0.6 | mA | 1 | 50° C. |
| | Discharging | 0.5 | C | — | 6 | 2.5 | V | | |
| Cycle-3rd | Charging | 1.0 | C | 4.3 V | 12 | 0.6 | mA | 1 | 50° C. |
| | Discharging | 1.0 | C | — | 12 | 2.5 | V | | |
| Cycle-4th | Charging | 2.0 | C | 4.3 V | 24 | 0.6 | mA | 1 | 50° C. |
| | Discharging | 2.0 | C | — | 24 | 2.5 | V | | |
| Cycle-5th | Charging | 0.2 | C | 4.3 V | 2.4 | 0.6 | mA | 1 | 50° C. |
| | Discharging | 0.2 | C | — | 2.4 | 2.5 | V | | |
| Cycled | Charging | 0.1 | C | 4.3 V | 1.2 | 0.6 | mA | 100 | 50° C. |
| | Discharging | 0.1 | C | — | 1.2 | 2.5 | V | | |

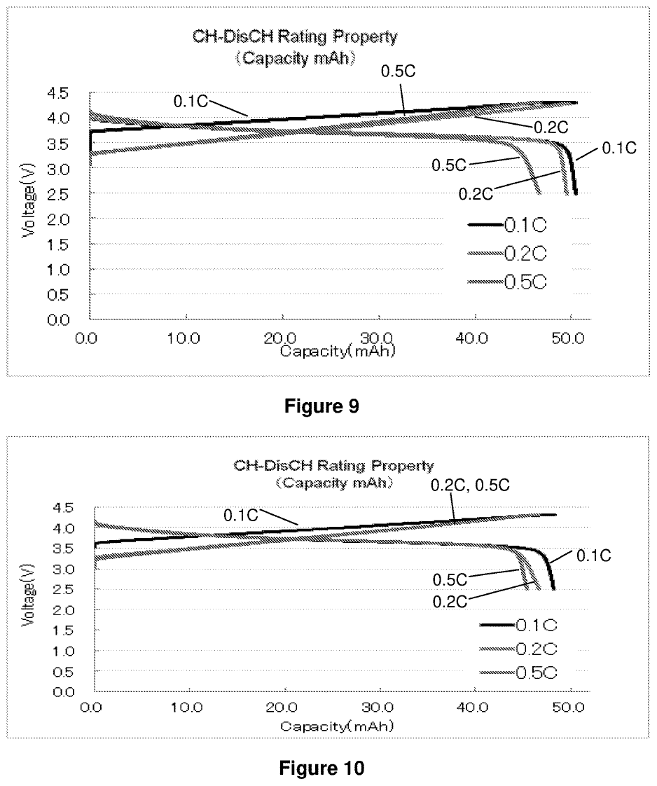

Cycling results at 0.1 C, 0.2 C and 0.5 C are shown in FIG. 9. At 0.2 C rating, the measured capacity was 49.64 mAh, providing a Coulombic efficiency rate of 99.6%. The effect of 100 cycles at 0.1 C, 50° C. was to gradually reduce the measured capacity from 50.2 mAh to 47.7 mAh, thus providing a capacity retention of 94.9%.

### Example 5. Fabrication and Testing of a Lithium Metal Cell Comprising a Solid-State NASICON-Based Electrolyte

Another Li metal/NMC811 cell having the configuration of cell 500 described herein with reference to FIG. 5 (with component layers numbered accordingly) was prepared and evaluated.

Fabrication. The cell was prepared by the same method as Example 4, except that LATP was used instead of LLZO-Nb in step 4. The resultant solid inorganic (NASICON-based) electrolyte layer (516) on the polymeric catholyte layer (514) had a thickness of about 30 μm.

Cell testing. The cell was evaluated using the same test procedure set out in Example 4. Cycling results at 0.1 C, 0.2 C and 0.5 C are shown in FIG. 10. At 0.2 C rating, the Coulombic efficiency rate was 99.9%. The effect of 100 cycles at 0.1 C, 50° C. was to gradually reduce the measured capacity from 48.8 mAh to 44.9 mAh, thus providing a capacity retention of 92.8%.

### Example 6. Fabrication and Testing of a Lithium Metal Cell Comprising a Solid-State Sulfide-Based Electrolyte

Another Li metal/NMC811 cell having the configuration of cell 500 described herein with reference to FIG. 5 (with component layers numbered accordingly) was prepared and evaluated.

Fabrication. The cell was prepared by the same method as Example 4, except for variations in step 4.

Step 4. An electrolyte solution was prepared by combining LiPSCl (50 wt. %), a polyalkylene triol polyacrylate (GEP-2800AA) (12 wt. %) and LiFSI lithium salt (14 wt. %) with THF (24 wt. %). The mixture was then blended with a planetary centrifugal mixer (2×5 min), further diluted with THF to an optimum viscosity (achieved at 65% non-volatile content) and passed through a filtration sieve. A UV-polymerisation catalyst (OMNIRAD 651, a 2,2-dimethoxy-2-phenylacetophenone based photoinitiator) was added in an amount of 1% relative to GEP-2800AA. The sulfide-based electrolyte coating slurry was coated on the polymeric catholyte layer (514) and subjected to polymerization under UV irradiation at 254 nm for 30 minutes, then dried at 40° C. for 1 hour to provide a solid inorganic (sulfide-based) electrolyte layer (516) on the polymeric catholyte layer (514) with a thickness of about 30 μm.

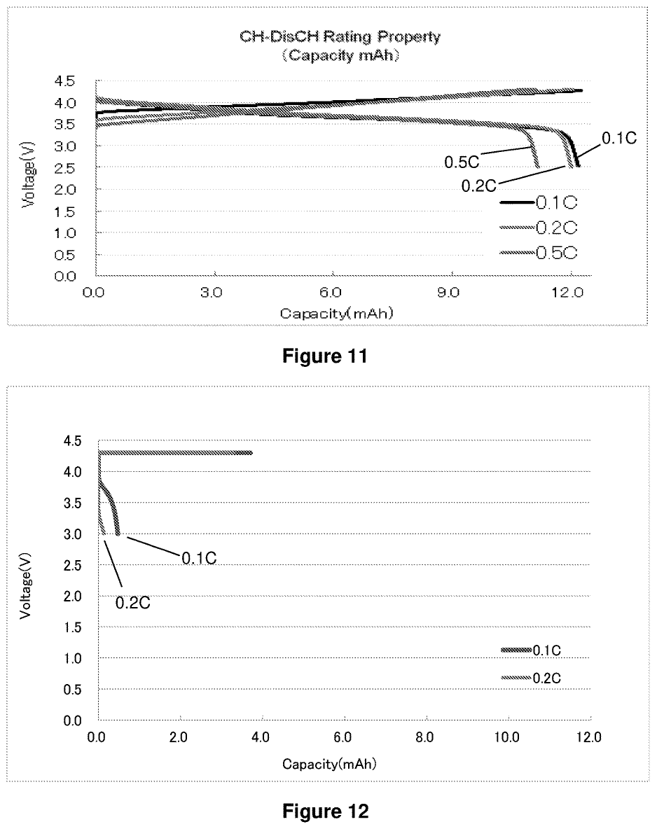

Cell testing. The cell was evaluated using the same test procedure set out in Example 4, except that the cell size was only 3 cm×3 cm (capacity about 12 mAh). Cycling results at 0.1 C, 0.2 C and 0.5 C are shown in FIG. 11. At 0.2 C rating, the Coulombic efficiency rate was 99.8%. The effect of 100 cycles at 0.1 C, 50° C. was to gradually reduce the measured capacity from 11.3 mAh to 10.5 mAh, thus providing a capacity retention of 92.9%.

### Example 7 (Comparative). Fabrication and Testing of a Solid-State Lithium Metal Cell without Separation of the Polymeric Anolyte Layer from the Cathode

A Li metal/NMC622 cell was prepared and evaluated as follows.

Fabrication. The cell was prepared by the same method as Example 2, except for the omission of steps 3, 4 and 5. Thus, with reference to FIG. 3, Pilblox-based anolyte layer (112) was directly in contact with cathode (104) (layers 314, 316 and 312 omitted).

Cell testing. The cell was evaluated at high voltage (4.3V) using the same test apparatus described in Example 2, except that the cell size was only 3 cm×3 cm (theoretical capacity about 13.5 mAh) and testing was conducted at ambient temperature (25° C.). As seen in FIG. 12, the device was inoperative. At 0.2 C rating, the Coulombic efficiency rate was only 4.1%. It is believed that the poor performance is due to high grain boundary resistance and chemical/electrochemical instability of the Pilblox-based anolyte layer in contact with the cathode.

### Example 8. Effect of Pilblox Polymer Structure on Formation of a Polymeric Anolyte Layer

A coating slurry for anolyte preparation was prepared by dissolving the lower molecular weight diblock copolymer PS-b-PIL (as prepared in Example 1) (9 wt. %) in tetahydrofuran (THF) (81.7 wt. %), followed by addition of MPPY-FSI ionic liquid (4.2 wt. %) and LiFSI lithium salt (5.1 wt. %). The coating slurry was coated on lithium metal foil at different loadings, followed by drying, with the aim of producing Pilblox-based anolyte layers of different thicknesses on a lithium anode. Continuous polymeric anolyte layers of high structural integrity could only be produced with a thickness of at least 100 μm with this specific formulation, which contrasts against anolyte layer thickness of less than 10 μm achieved when using the high molecular weight triblock copolymer PS-b-PIL-b-PS (see e.g. Example 2).

Without wishing to be limited by any theory, it is proposed that the PS-b-PIL-b-PS triblock copolymer provides better mechanical properties for thin film formation due to the high molecular weight, particularly of the hydrophobic polystyrene blocks. Polystyrene undergoes chain entanglement at higher molecular weight, specifically above about 18,000 Da (the chain entanglement molecular weight), resulting in a significant increase in bulk mechanical strength properties compared to polystyrene having a molecular weight below about 18,000 Da. Furthermore, the triblock structure may allow a single polymer molecule to span three adjacent domains in the solid polymer microstructure, with the two polystyrene blocks present in different disconnected hydrophobic domains bridged by the polymerized ionic liquid block in the intermediate hydrophilic domain. This bridging of A-block domains in combination with chain entanglement, is a feature of ABA-type triblock copolymer elastomers and is largely responsible for the enhanced bulk mechanical properties of such materials. These features may be responsible for allowing thin film formation with high structural integrity.

A Li metal/NMC622 cell was prepared by the same method as Example 2, except that the Pilbox-based anolyte layer produced in step 1 comprised the lower molecular weight diblock polymer PS-b-PIL and had a thickness of 120 μm (prepared as discussed above), and steps 4 and 5 were omitted. Thus, with reference to FIG. 3, the thick Pilblox-based anolyte layer (112) was directly in contact with polymeric catholyte layer (214) (layer 212 omitted).

The cell was evaluated at high voltage (4.3V) using the same test apparatus described in Example 2, except that the cell size was only 3 cm×3 cm (theoretical capacity about 13.5 mAh). The cell was cycled at 0.2 C between 4.3 V and 3.0V, achieving a coulombic efficiency of 98.7%.

### Example 9. Effect of Free Ionic Liquid on Lithium Conductivity

A coating slurry for anolyte preparation was prepared by dissolving the lower molecular weight diblock copolymer PS-b-PIL (as prepared in Example 1) (20 wt. %) in acetone (76 wt. %), followed by addition LiFSI lithium salt (4 wt. %). No free ionic liquid was included in the formulation. The coating slurry was coated on lithium metal foil (100 μm thickness) as a double coating, by applying a first coating of 350 μm wet thickness, drying at 60° C. for 10 minutes, applying a second coating of 450 μm wet thickness, and drying at 80° C. for 30 minutes. The resultant Pilblox-based anolyte had a thickness of 125 μm.

A Li metal/NMC622 cell was prepared by a similar method as described in Example 2, except in a CR2032 coin cell format. Step 1 of the Example 2 method was replaced by preparing the Pilbox-based anolyte layer described above. In step 2, the porous NMC622-based cathode (104) had a capacity of 1.5 mAh/cm². Step 5 was omitted, since two layers of Pilblox were coated directly on the Li anode. Thus, with reference to FIG. 3, the Pilblox-based anolyte layers (112, 312), which did not contain free ionic liquid, were in contact with a solid polymeric intermediate electrolyte layer (314).

The cell was evaluated at high voltage (4.3V) and 50° C., cycling the cell between 4.3 V and 3.0V. The solid electrolyte layers between the cathode and the Pilblox-based anolyte layers remained protective of the Pilblox composition against oxidative degradation. However, coulombic efficiencies of only 84.4%, 53.3 and 2.6% were obtained at cycling rates of 0.1 C, 0.2 C and 0.50, respectively. The cell has a conductivity of only 3.3×10⁻⁸ S/cm.

The poor cycling results and low conductivity of the cell demonstrate the role of free ionic liquid in the solid electrolyte layers to facilitate lithium conductivity through the electrolyte composition and/or across the interface between the electrolyte layer and adjacent layers in the cell.

Those skilled in the art will appreciate that the invention described herein is susceptible to variations and modifications other than those specifically described. It is understood that the invention includes all such variations and modifications which fall within the spirit and scope of the present invention.

1. A rechargeable lithium metal cell, comprising:
an anode comprising lithium metal;
a cathode comprising a high-voltage cathode material; and
a plurality of lithium-conductive layers interposed between the anode and the cathode, the lithium-conductive layers comprising a solid polymeric anolyte layer adjacent the anode and one or more further electrolyte layers which space apart the solid polymeric anolyte layer from the cathode,
wherein the solid polymeric anolyte layer comprises (i) a block copolymer comprising at least one hydrophobic non-ionic block and at least one ionic block, and (ii) lithium salt, and wherein the solid polymeric anolyte layer has at least two glass transition temperature (Tg) values.

2. (canceled)

3. (canceled)

4. (canceled)

5. (canceled)

6. (canceled)

7. The rechargeable lithium metal cell according to claim 1, wherein the at least one hydrophobic non-ionic block comprises polymerised residues of hydrophobic monomers and the at least one ionic block comprises polymerised monomer residues having covalently coupled thereto (a) a pendant organic ionic liquid cation, the pendant organic ionic liquid cation having a counter anion, (b) a pendant anionic moiety, the pendant anionic moiety having a counter cation, or (c) a combination thereof.

8. The rechargeable lithium metal cell according to claim 1, wherein the at least one ionic block comprises polymerised monomer residues having covalently coupled thereto a pendant organic ionic liquid cation selected from imidazolium, pyrrolidinium, phosphonium, pyridinium and ammonium cations.

9. The rechargeable lithium metal cell according to claim 1, wherein the solid polymeric anolyte layer further comprises an organic electrolyte selected from a free ionic liquid, a polar aprotic molecular compound and combinations thereof.

10. The rechargeable lithium metal cell according to claim 1, wherein the solid polymeric anolyte layer has a thickness of less than 20 μm and/or wherein the polymeric anolyte layer is spaced apart from the cathode by a separation distance in the range of 15 to 45 μm.

11. The rechargeable lithium metal cell according to claim 1, wherein the solid polymeric anolyte layer is a coating on the anode.

12. (canceled)

13. The rechargeable lithium metal cell according to claim 1, wherein at least one of the further electrolyte layers comprises an organic electrolyte selected from a free ionic liquid, a polar aprotic molecular compound and combinations thereof.

14. The rechargeable lithium metal cell according to claim 1, wherein each of the further electrolyte layers comprises a free ionic liquid.

15. The rechargeable lithium metal cell according to claim 1, wherein the one or more further electrolyte layers comprise a solid catholyte layer adjacent the cathode, wherein the solid catholyte layer is selected from a solid polymeric catholyte layer and a solid inorganic electrolyte layer.

16. The rechargeable lithium metal cell according to claim 15, wherein the solid catholyte layer is a solid polymeric catholyte layer comprising a fluorinated polymer.

17. The rechargeable lithium metal cell according to claim 16, wherein the fluorinated polymer is an ionic fluorinated polymer comprising a carbon-chain backbone and pendant ionic groups covalently coupled to the carbon-chain backbone.

18. The rechargeable lithium metal cell according to claim 17, wherein the pendant ionic groups are produced by graft polymerization of an ionic monomer onto the carbon-chain backbone, the ionic monomer comprising (i) a polymerizable ethylenically unsaturated functional group, and (ii) an organic ionic liquid cation.

19. The rechargeable lithium metal cell according to claim 15, wherein the one or more further electrolyte layers comprise an intermediate electrolyte layer interposed between the solid polymeric anolyte layer and the solid catholyte layer, wherein the intermediate electrolyte layer is selected from a solid polymeric electrolyte layer, a solid inorganic electrolyte layer and a liquid electrolyte layer.

20. The rechargeable lithium metal cell according to claim 19, wherein the intermediate electrolyte layer is a solid polymeric electrolyte layer and wherein the intermediate electrolyte layer comprises a lithium-conductive polymeric composition comprising (i) an ionic fluorinated polymer comprising a carbon-chain backbone and pendant ionic groups covalently coupled to the carbon-chain backbone, (ii) lithium salt, and optionally (iii) a free ionic liquid.

21. The rechargeable lithium metal cell according to claim 19, wherein the intermediate electrolyte layer is a solid polymeric electrolyte layer or a liquid electrolyte layer and wherein the intermediate electrolyte layer comprises a porous separator infiltrated with (i) a lithium-conductive polymeric composition or (ii) a liquid electrolyte comprising lithium salt.

22. The rechargeable lithium metal cell according to claim 19, wherein the intermediate electrolyte layer comprises a solid inorganic electrolyte layer comprising mobile lithium ions, wherein the solid inorganic electrolyte layer comprises a lithium-containing inorganic material selected from a garnet, a NASICON-type material, a sulfide and a perovskite.

23. The rechargeable lithium metal cell according to claim 1, wherein the one or more further electrolyte layers comprise a second polymeric anolyte layer comprising (i) a block copolymer comprising at least one hydrophobic non-ionic block and at least one ionic block, and (ii) lithium salt, the second polymeric anolyte layer adjacent the solid polymeric anolyte layer and spaced apart from the cathode.

24. (canceled)

25. A method of cycling the rechargeable lithium metal cell according to claim 1, the method comprising one or more cycles of (i) charging the rechargeable lithium metal cell to a charge cut-off voltage of at least 4.1 V, and (ii) discharging the rechargeable lithium metal cell.

26. A method of producing a rechargeable lithium metal cell according to claim 23, the method comprising:
providing an anode half-cell comprising the anode and the solid polymeric anolyte layer;
providing a cathode half-cell comprising the cathode; and
assembling the anode half-cell and the cathode half-cell to provide the rechargeable lithium metal cell with the plurality of lithium-conductive layers interposed between the anode and the cathode,
wherein the cathode half-cell comprises, as an outer layer, a second polymeric anolyte layer comprising the block copolymer and lithium salt, and wherein assembling the anode half-cell and the cathode half-cell comprises bonding the solid polymeric anolyte layer to the second polymeric anolyte layer.

27. (canceled)

28. (canceled)

29. (canceled)

30. A cathode half-cell comprising:
a cathode comprising a high-voltage cathode material, the cathode supported on a current collector;
a solid polymeric anolyte layer; and
one or more further electrolyte layers which space apart the solid polymeric anolyte layer from the cathode,
wherein the solid polymeric anolyte layer comprises: (i) a block copolymer comprising at least one hydrophobic non-ionic block and at least one ionic block, and (ii) lithium salt, and wherein the solid polymeric anolyte layer has at least two glass transition temperature (Tg) values.
